(19) United States
(12) Patent Application Publication
(10) Pub. No.: US 2010/0228963 A1
(43) Pub. Date: Sep. 9, 2010

(54) METHODS OF PLACING ADVERTISMENTS, INTERSTITIALS AND TOOLBARS IN A WEB BROWSER

(75) Inventors: Hisham Kassab, Rockville, MD (US); Saad Mneimneh, New York, NY (US); Won Yoon, Boston, MA (US)

Correspondence Address: FITCH, EVEN, TABIN & FLANNERY, P. O. BOX 18415, WASHINGTON, DC, 20036, US

(73) Assignee: Mobilaps, LLC, Silver Spring, MD (US)

(21) Appl. No.: 12/530,403

(22) PCT Filed: Mar. 7, 2008
(86) PCT No.: PCT/US2008/056266

§ 371 Date: May 19, 2010

Related U.S. Application Data
(60) Provisional application No. 60/905,615, filed on Mar. 8, 2007.

(51) Int. Cl. G06F 15/16; H04L 9/00

(52) U.S. Cl. 713/150; 709/203

(57) ABSTRACT

The present invention provides methods and systems that can render INE content to a web browser. Various methods and approaches are disclosed that when implemented would enable an INE to place some of INE's contents in a web browser of a user. The INE content can be in the form of a tool bar or interstitial content. The invention can provide one or more of the following advantages: a) provide an opportunity for INE to conduct e-commerce, b) enable an INE to develop alternate revenue generation model, and c) enable an INE or it's related entities to participate in e-commerce and advertising.

### CLAIM OF PRIORITY

This patent application claims priority to and benefit of the filing date of U.S. Provisional Patent Application Ser. No. 60/905,615, filed Mar. 8, 2007, and entitled “METHOD FOR PROVIDING A WEB PAGE WITH INSERTED TOOLBAR OR INTERSTITIAL CONTENT,” the entire contents of which are hereby expressly incorporated by reference.

### CROSS-REFERENCE TO RELATED APPLICATIONS

This application hereby incorporates by reference a co-pending U.S. Non-Provisional Application No. 11/129,476, filed on May 16, 2005 entitled “METHOD OF PROVIDING A WEB PAGE WITH INSERTED CONTENT”; and PCT/US2007/079,851, claiming priority to U.S. Provisional Application No. 60/848,193, filed on Sep. 28, 2006, entitled “METHODS AND SYSTEMS FOR PROVIDING A MINI-WEBPAGE WITHIN A WEB PAGE”.

### FIELD OF THE INVENTION

The invention generally relates to the field of software and internet, and more specifically to methods and systems that would facilitate rendering of an intermediate network entity content to a web browser.

### BACKGROUND OF THE INVENTION

In this application, the terms Internet Service Provider (ISP) and Intermediate Network Entity (INE) are used interchangeably. For purposes of this application, any entity on the path between a client and a server will be referred to as an “intermediate network entity” (INE). ISPs, in general, have increasingly been relegated to commoditized bit-pipes that carry Internet traffic from the user to different portals and websites on the World Wide Web. Despite the dotcom bust, surviving companies such as YAHOO, AMAZON, EBAY, and GOOGLE (registered service marks) are thriving. However, ISPs have been largely kept out of this business.

Conventional ISPs have experimented with Point-of-Sale (POS) advertising on a user's screen using several technologies/means including (1) unsolicited pop-up windows; and (2) URL redirection, whereby the user, upon starting up the web browser, is redirected to a login page that typically contains advertising for the location owner. Despite these attempts, it is unknown in the art to provide INE content, such as a tool bar and the like, into a web page and/or within a web browser.

### SUMMARY OF THE INVENTION

The following presents a simplified summary of the present invention to provide a basic understanding of some of its aspects. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention includes various systems and methods for placing INE content into a web page and/or within a web browser.

One possible form of INE content that can be placed in a web page and/or web browser includes a toolbar that can be advantageously used by the INE or its related entities. The INE content may look and function as a toolbar, but may or may not require any client-side software download/installation. One or more embodiments of the present invention use a procedure to conduct one ore more tests to determine how to proceed with placing the INE content.

An aspect of the present invention is to provide a system and method for an ISP and/or an INE to place a toolbar or interstitial content (interstitial content is intended to include one or more web pages and/or content that are displayed within a web browser before the web browser displays the requested web content). One or more systems and methods can permit ISPs or other entities to provide e-commerce, e-services, advertising or other services that are integrated with the presentation of content provided to the user. Some of the disclosed methods and systems can be used as a revenue generating tools by an INE.

In another aspect of the present invention, a method for rendering an INE platform within a web browser is described. This method can involve receiving a request for web content located at a specified web address from a web browser by at least one of an INE and a web server; processing, by a processing agent within an INE, one or more responses generated by the at least one of an INE and a web server as an answer to the request for the web content, the processing of one or more responses further includes making a determination on which INE processed response to forward to the web browser from one or more of the following: a procedure that determines one or more parameters of the state of the web browser, a modified response, and an unmodified response; generating new web content comprising the requested web content and an INE platform; and rendering the new web content comprising the requested web content and the INE platform to the web browser. The new web content can be displayed within the web browser prior to displaying the requested web content.

In another aspect of the present invention, a method for rendering an INE platform within a web browser is described. The method can involve receiving a request for web content located at a specified web address from a web browser by at least one of an INE and a web server; processing, by a processing agent within an INE, one or more responses generated by the at least one of an INE and a web server as an answer to the request for the web content, the processing of one or more responses further comprises making a determination on which INE processed response to forward to the web browser from one or more of the following: a procedure that determines one or more parameters of the state of the web browser, a modified response, and an unmodified response; generating new web content comprising the requested web content and an INE platform; and rendering the new web content comprising the requested web content and the INE platform to the web browser.

In yet another aspect of the present invention, a method for rendering an INE platform in the form of a toolbar within a web browser is disclosed that can involve extending functionality of a web browser by installing software to introduce a toolbar. In this aspect of the invention, the toolbar can appear selectively based on whether an electronic device is connected to an INE that provides the toolbar.

The methods and systems disclosed can be used in various environments, such as in a public Wi-Fi hotspot controller or a regional ISP, which can use the dedicated INE platform to provide a range of services and/or software applications such as e-commerce, advertising, discount coupons, and the like. Other variations and embodiments are described in more detail below, and the invention is not intended to be limited in any way by this brief summary.

### BRIEF DESCRIPTION OF DRAWINGS

The foregoing features, as well as other features, will become apparent with reference to the description and figures below, in which like numerals represent elements and in which:

FIG. 1 is a prior art schematic diagram of a general-purpose digital computing environment.

FIG. 2 provides a prior art illustration of various client-server architectures using web browsing architecture.

FIG. 3 illustrates prior art of how a client and server may be connected via the Internet.

FIG. 4 shows a prior art passage of Internet traffic between one or more proxy servers before flowing through the Internet.

FIG. 5 shows how a web page can be displayed in a web browser including a dedicated platform containing inserted content and conventional web content according to one aspect of the invention.

FIG. 6 shows how a web page can be displayed in a web browser including a dedicated platform containing inserted content and conventional web content according to another aspect of the invention.

FIG. 7 illustrates a prior art process that is undertaken when an INE user downloads a webpage from an origin server.

FIG. 8 shows the prior art use of a conventional web browser toolbar.

FIG. 9 shows a prior art Internet Content Adaptation Protocol (ICAP) technique.

FIG. 10 shows one possible software architecture according to one aspect of the present invention.

FIG. 11 is a block diagram of processing HTTP responses according to one embodiment of the present invention.

FIG. 12 is block diagram of a procedure that may execute within the web browser according to one embodiment of the present invention.

FIG. 13 is a block diagram of processing HTTP requests according to one embodiment of the present invention.

FIG. 14 is a block diagram of a procedure that may execute within the web browser for processing flagged URIs for Embedded Link Requests according to one embodiment of the present invention.

FIG. 15 is a block diagram of a procedure that may execute within the web browser for processing unflagged URIs according to one embodiment of the present invention.

FIG. 16 is a block diagram of processing HTTP responses according to one embodiment of the present invention.

FIG. 17 is a block diagram of a procedure that may execute within the web browser according to one embodiment of the present invention.

### DETAILED DESCRIPTION OF THE INVENTION

The different aspects of the present invention are now described with reference to the drawings, wherein like reference numerals are used to refer to like elements throughout. In the following description, for purposes of explanation, numerous specific details are set forth to provide a thorough understanding of the invention. It may be evident, however, that the aspects of the invention can be practiced without these specific details. In other instances, well-known structures and devices are shown in block diagram form to facilitate describing different aspects of the invention.

The term Web Page described herein is intended to include any web content that can be viewed within a web browser including but not limited to content created using HTML, audio and video streams, JavaScript, Java Applets, Flash, Shockwave, CGI, and the like. The term INE is intended to include any entity on the path between a client and a server, for example, an Intermediate Network Entity. In this application, an ISP may be referred to as an INE, however, not all INEs are ISPs. In other words, ISPs form a subset of INEs. Also in this application, the term Requested Web Content is intended to refer to web content at a specified web address, whereby the web content is requested by a user and/or a web browser.

The present invention generally relates to methods and systems that provide an INE such as an ISP with an ability to place or cause to place toolbars or interstitial content within a web browser. One or more aspects of the present invention can advantageously provide INEs with tools to beneficially leverage Internet advertisement and/or e-commerce and/or e-services revenue. The aspects of the invention can be implemented using one or more methods described below. Below are some general examples of systems and methods that can be used to implement one or more aspects of the invention.

### Illustrative Example of General Purpose Digital Computing Environment That Can be Used With One or More Embodiments

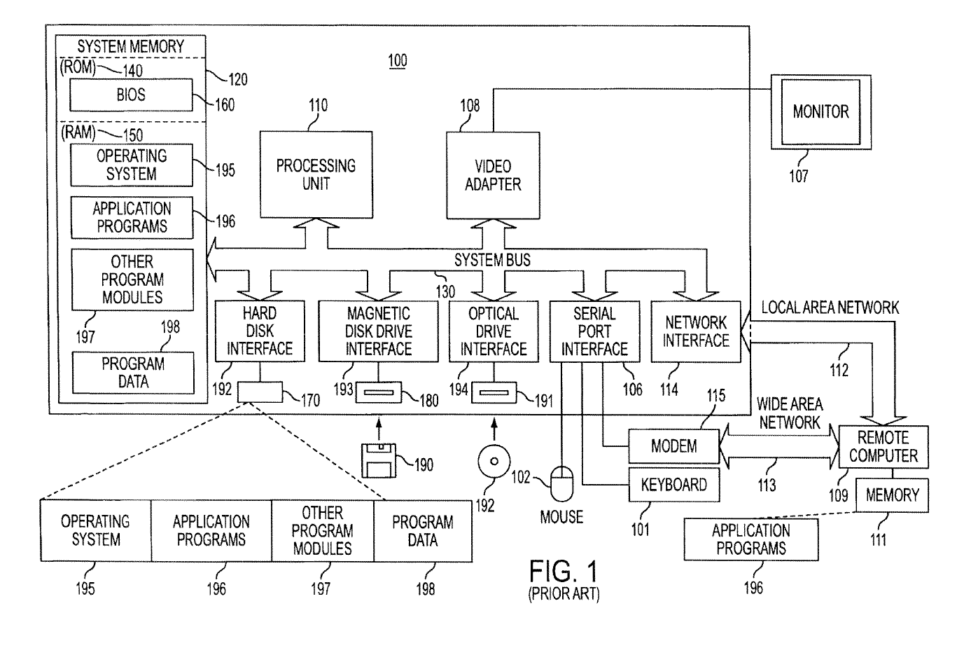

FIG. 1 is a schematic diagram of a conventional general-purpose digital computing environment that can be used to implement some of the aspects of the invention. Computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory includes read only memory (ROM) 140 and random access memory (RAM) 150.

A basic input/output system 160 (BIOS), containing the basic routines that help to transfer information between elements within the computer 100, such as during start-up, is stored in ROM 140. Computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192 such as a CD ROM or other optical media. The hard disk drive 170, the magnetic disk drive 180, and the optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the computer 100. It will be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs), and the like, may also be used in the exemplary operating environment.

A number of program modules can be stored on the hard disk drive 170, the magnetic disk drive 190, the optical disk drive 192, the ROM 140 or the RAM 150, including an operating system 195, one or more application programs 196, other program modules 197, and program data 198. A user can enter commands and information into the computer 100 through input devices such as a keyboard 101 and pointing device 102. Other input devices (not shown) may include a microphone, joystick, game pad, satellite dish, scanner, or the like. These and other input devices are often connected to the processing unit 110 through a serial port interface 106 that is coupled to the system bus, but may be connected by other interfaces, such as a parallel port, game port or a universal serial bus (USB). A monitor 107 or other type of display device is also connected to the system bus 130 via an interface, such as a video adapter 108. In addition to the monitor, personal computers typically include other peripheral output devices (not shown), such as speakers and printers.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the computer 100 typically includes a modem 115 or other means for establishing a communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device.

It will be appreciated that the network connections shown are exemplary and other means of establishing a communications link between the computers can be used. The existence of any of various well-known protocols such as TCP/IP, Ethernet, FTP, HTTP and the like is presumed, and the system can be operated in a client-server configuration to permit a user to retrieve Web Pages from a web-based server. Any of various conventional web browsers can be used to display and manipulate data on Web Pages.

### Client-Server Architecture

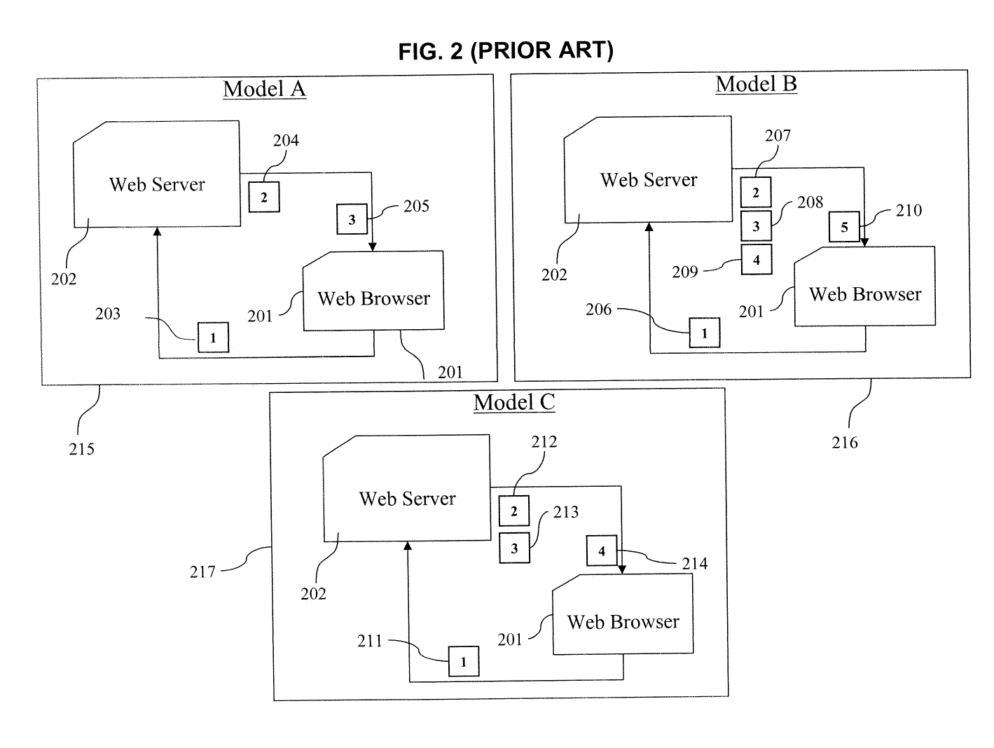

FIG. 2 provides an illustration of various client-server architectures using the widely used web browsing architecture that can be used to implement one or more aspects of the invention. As FIG. 2 illustrates, web browsing has a client-server architecture, whereby the client 201 is typically referred to as a web browser, and the server 202 is typically referred to as a web server. In Model A 215, the interaction begins the web browser requesting 203 a particular HTML file. The web server locates the file and sends it to the web browser 204, and the web browser displays the file 205. In Model A 215, the HTML page is static, which means it will not change unless it is explicitly modified by its author/developer. In Model B 216, the web server performs some processing, based on CGI technology. After the web browser sends its request 206, the web server locates an appropriate CGI program and passes the request to that CGI program 207. The CGI program processes the request and sends the resulting output data back to the web server 208. The web server then sends that data back to the web browser 209, and the web browser displays the data 210. In Model B 216, the CGI program generates a dynamic HTML page. The contents of the page depend on the query passed to the CGI program. Model C 217 shows another case involving a dynamic response. In this model, the dynamic response is generated using server side technologies such as (1) Personal Home Pages (PHP); (2) Active Server Pages (ASP); (3) Java Server Pages; and (4) Server Side Includes (SSI). In Model C 217, after the web browser sends its request 211, the web server checks the corresponding file and executes any embedded scripts 212, and puts together the final formatted document to be sent to the web browser 213. The web browser then displays the document 214.

Clients and servers communicate with each other using a set of instructions, referred to as protocols, over networks. Indeed, networks may be considered the backbone of client-server relationships. Clients may communicate with servers over any of various conventional networking technologies including but not limited to (1) Ethernet-based local area networking; (2) wide area networking; and (3) TCP/IP-based Internet networking.

The Internet has become widely used network for various client-server applications. Indeed, the Internet revolves around the client-server architecture. Client-server applications available over the Internet include but are not limited to (1) web browsing; (2) email; (3) gaming; (4) streaming audio; (5) streaming video; (6) file transfer; (7) special-purpose applications; and the like. Among the widely available clients used in Internet-based client-server applications are: (1) Web browsers such as Internet Explorer, Firefox, Netscape (including media players within the web browser); (2) Email clients such as Netscape Communicator, Microsoft Outlook, Microsoft Outlook Express, and Eudora; (3) Newsgroups clients; (4) instant messaging applications; (5) audio players such as RealPlayer; (6) video players such as MediaPlayer; (7) custom-made applications such as Softphones for Voice-Over-IP. The client device hosting the client software is typically a client computer; however, it may also be a dedicated device such as a television (TV), an audio player or a game player. Any or all of the above may be used in conjunction with one or more aspects of the present invention.

A request for service sent from a client to a server can be referred to as a request message. An example of a request message is an HTTP request. The service provided by the server can be referred to as a response message. One example of a response message is one that contains an HTML document that is typically provided by a web server.

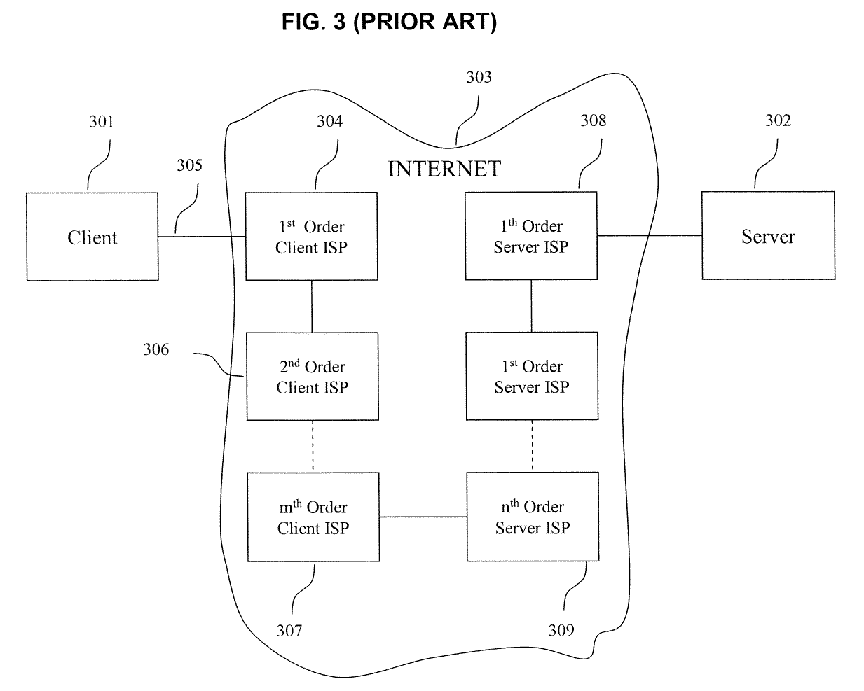

FIG. 3 illustrates how a client 301 and server 302 can connect via the Internet 303. Client 301 typically has an Internet Service Provider (ISP), such as first-order ISP 304. Client 301 connects to 304 via path 305, which can be any of several types of connection including but not limited to dial-up, DSL, cable modem, fixed wireless, Wi-Fi, and cellular. First-order ISP 304 can have its own ISP, 306, which in turn, can have its own ISP and so on. FIG. 3 depicts a hierarchy of m ISP's on the client side. A similar structure exists on the server side, where the server has an ISP 308, which itself is part of a chain of ISP's that goes up to an nth ISP 309, which connects with the mth ISP on the client side. (The mth client ISP and the nth server ISP can be the same ISP.) The point of FIG. 3 is that Internet traffic/data exchanged between the client 301 and the server 302 typically passes through the gateways (also known as edge routers) of several Internet Service Providers.

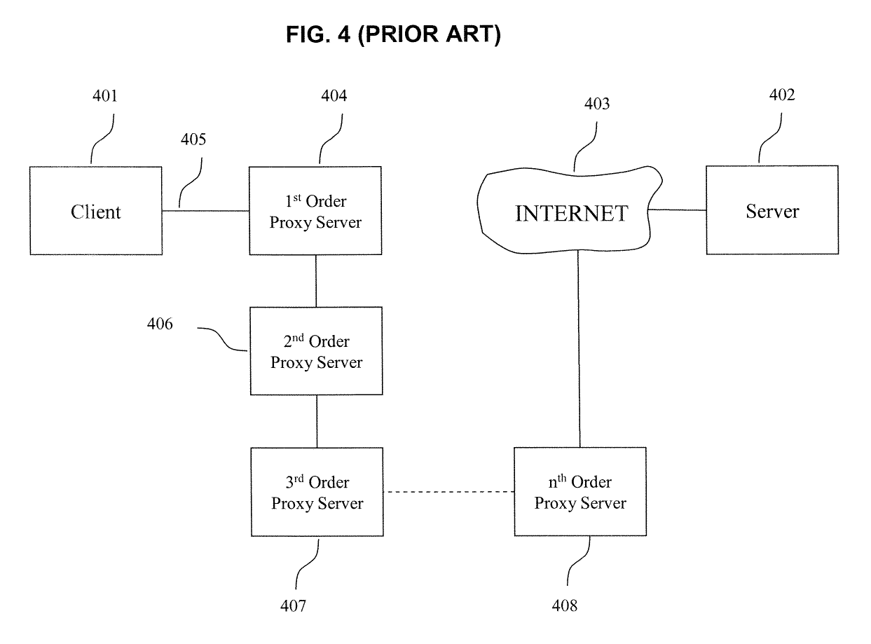

FIG. 4 shows that Internet traffic between a client 401 and a server 402 may pass through one or more proxy servers 404 before flowing through the Internet 403. A proxy server “hears” and services requests from its clients, often re-initiating requests on behalf of its clients and passing the corresponding responses to the clients. A client may explicitly redirect traffic to the proxy server, or the traffic may be redirected without the explicit specification of the client. The connection 405 between the client and the proxy server 404 may take several forms, including a point-to-point connection, a connection over a local area network, or a connection over the Internet. Also, as with the hierarchy of ISP's, it is possible to have a hierarchy of proxy servers 406, 407 and 408 as shown in FIG. 4.

FIG. 3 and FIG. 4 illustrate that there may be several entities on the path between a client and a server. This can be true even if the client and the server are on the same local area network or wide area network (i.e., not connected over the Internet). By virtue of being physically in the path between the client and the server, an INE potentially can modify the client's request message before it reaches the server, as well as the server's response message before it reaches the client. An INE can have a proxy server; an ISP; or a VPN device, for example.

### HTTP Requests

There are at least two types of an HTTP request, in terms of how an HTTP request is generated. The first is a Link Request, which is an HTTP request that is generated when for an example a user clicks on a hyper-link in a Web Page, or enters an address in the Uniform Resource Identifier (URI) address box. The second type is an Embedded Object Request, which is generated by the web-browser automatically as it parses a Web Page and identifies embedded objects (e.g., images, JavaScript etc) for which separate HTTP requests need to be generated. An Embedded Object Request may be in several forms including but not limited to: a) the HTML attribute “src” followed by “=” and a URI, and b) a JavaScript-generated HTTP request. The HTTP request itself typically consists of a header and a body. The header contains several fields, most notably the Cookie field and the URI field.

URI stands for Uniform Resource Identifier, and it has several other names such as WWW address, Universal Document Identifier, and Uniform Resource Locators (URL). For the HTTP protocol, URIs are simply formatted strings which identify (via name, location, or any other characteristic) a resource. In HTTP, URIs can be represented in absolute form or relative to some known base URI. Absolute URIs always begin with a scheme name followed by a colon e.g., http://www.CNN.com. A relative URI needs be used in conjunction with a base URI, and the combination would form an absolute URI.

### INE Platform

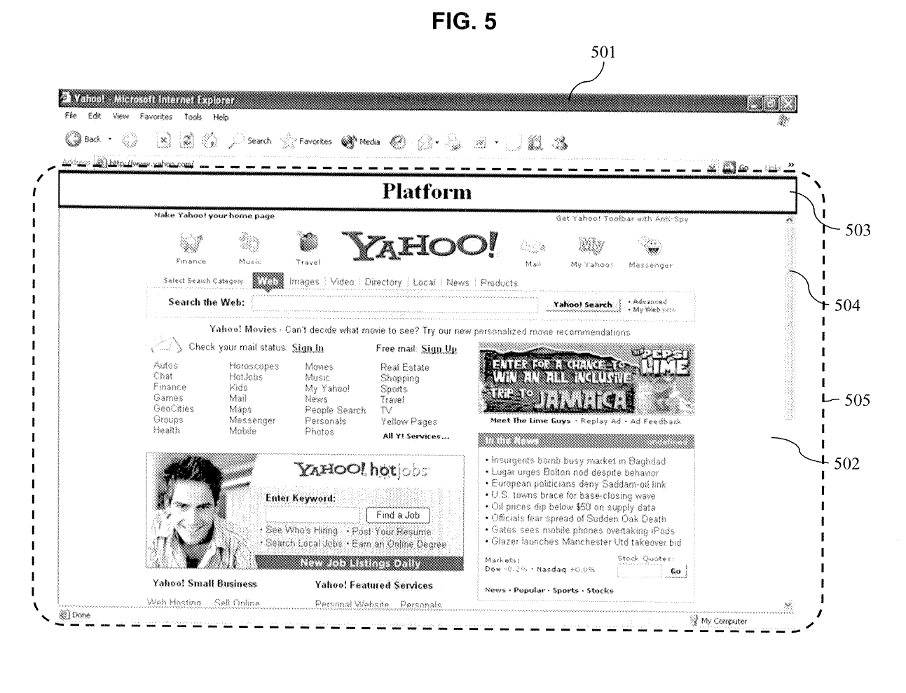

FIG. 5 provides an example of an INE platform according to one aspect of the invention. In FIG. 5, the client is a web browser 501, the response message is a web page 502. For the purpose of illustration, in this example, it is assumed that the INE is an ISP. The main web browser window 505 typically displays the response message. Therefore, normally the web page 502 would occupy all of the browser window 505. Instead, the browser window 505 according to one variation of the invention also contains an INE platform in the form of a toolbar 503 (INE toolbar). In this embodiment, the browser window 505 is actually displaying a frameset created by the ISP. A frameset divides a browser window into several “panes” and displays a different document inside each “pane.” These “panes” are referred to as frames. In FIG. 5, the ISP intercepted the original response message from the server, and repackaged it into a two-frame frameset, placing the original response message in the bottom frame and an INE toolbar in the top frame. In this example, the content of the INE toolbar 503 is controlled and driven by the ISP, and may be dynamic, changing constantly according to the specifications of the ISP.

According to one embodiment of this aspect of the invention, the INE toolbar 503 is placed at the top portion of the web browser window, and can remain in its position regardless of whether the user scrolls up and down using a scrollbar 504. It will be apparent to the persons skilled in the art, from the description provided later in this application, that the INE toolbar 503 may remain in place even as the user navigates to other web pages.

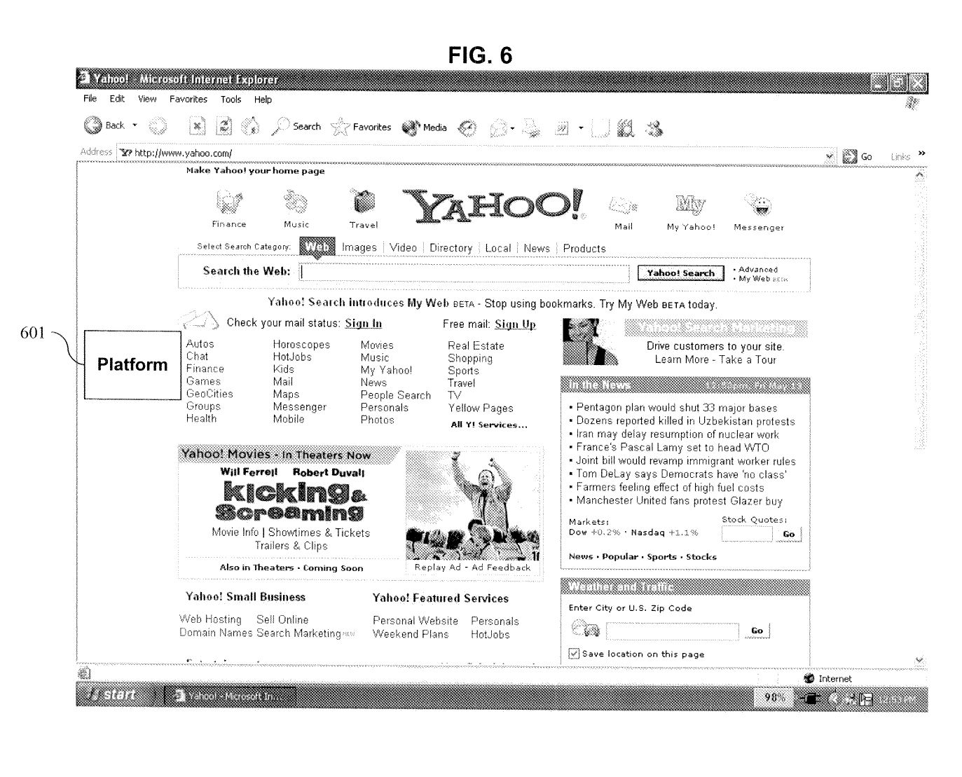

The INE platform shown in FIG. 5 is one example of an INE platform according to one aspect of the invention. Other examples for the INE platform include, but are not limited to:
1) A floating object, as depicted in FIG. 6. The floating object 601 is superimposed over the browser window and remains in its place as the user scrolls vertically and horizontally, and also as the user browses to other web pages;
2) An object within the requested web page, including but not limited to a banner object. This may entail removing an existing object within the requested web page (e.g., a banner ad) and replacing it with the said object. Other forms of this object may include: (a) a Flash animation object; (b) a Java applet; (c) an ActiveX control;
3) A hyperlink placed anywhere in the web page;
4) Macromedia Flash animation that is superimposed on the web page;
5) A separate application window, whereby the application is fundamentally different from the browser application;
6) A division/section in a document constructed using the <div> tag in conjunction with style sheets including cascading style sheets;
7) An inline frame (i-frame);
8) A custom toolbar similar to the Google and Yahoo toolbar.
9) In the case of the web browser being Internet Explorer, a band object similar to the commonly used “Favorites” and “Media” band objects. The band object is typically placed on the left side or the bottom of an Internet Explorer window; and
10) A native component of the web browser application (in the same way that the main browser window and the drop-down menus are native components). This native component would be designed to provide an INE platform for and interact with an INE.

The concept of rendering an INE platform is not limited to a web browsing application. It is also applicable to other client-server applications including but not limited to: email, streaming audio and streaming video. For an email client, the INE platform can take forms including but not limited to:
1) A native component of the email client designed to provide an INE platform that may interact with an INE;
2) A frame within the email body, similar to web browser 501, especially if the user's email client is equipped to display HTML content, which many of the email clients do;
3) A text message within the email body; and
4) A graphic object within the email body.

For an audio player, the INE platform may take forms including but not limited to:
1) A native component of the audio player designed to provide an INE platform that may interact with an INE;
2) Interrupting and buffering the audio stream to play an audio message from the INE; and
3) Superimposing or mixing audio on the audio stream.

For a video player, the INE platform may take forms including but not limited to:
1) A native component of the video player designed to provide an INE platform that may interact with an INE;
2) Interrupting and buffering stream to present own video content; and
3) Superimposing an object on the video display—the object may be interactive.

The functionality of the INE platform may provide one or more control features to the user, including but not limited to:
1) Changing background of the INE platform (in the case of a visual platform);
2) Changing the form of the INE platform (toolbar, frame, pop-up window);
3) Changing size of the INE platform (in the case of a visual platform);
4) Turning the INE platform on/off;
5) The physical position of the INE platform (in the case of a visual platform); and
6) The amount of acceptable animation/movement/interactivity within the INE platform.

In general, a combination of methods can be used to implement the INE platform (for the different web-applications) of the present invention. One exemplary method involves network-side/server-side implementation (Method A). In Method A, client side installation may not be required. The presentation, control, and maintenance of the INE platform can be performed by a computer/server on the network side. Another exemplary method involves installation and/or downloading of software on the user's computer/device to complement and/or extend the functionality of an existing client application on the computer/device (Method B). An example of an existing client application can be a generic web browser application. In this case, installed/downloaded client-side software results in the establishment of the INE platform, and subsequent coordination with the INE to control and maintain the content of the INE platform, including for example based on the user's location. Yet another exemplary method involves building the INE platform into a client application (Method C). Method C entails implementing the INE platform in the native code of the client application. For example, if the client application is a web browser, it may have a built-in capability to present an INE platform to the user, in coordination and collaboration with an INE. In other words, the mechanism for establishing the INE platform would be part and parcel of the client application's source code. Method C would apply for example if the INE platform were built into a web browser application.

Method A will be illustrated, by describing how it can be applied to the web browsing application, to implement certain forms of the INE platform for the web browser. Several elements of the description will be applicable to other forms of the web browser INE platform, as well as INE platforms for other client-server applications.

### Downloading Web Pages

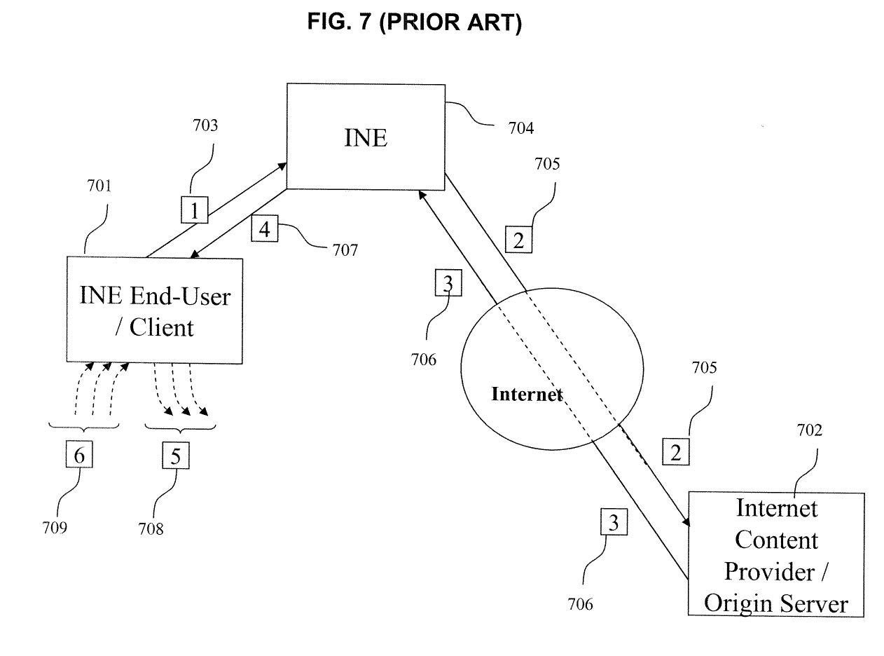

FIG. 7 provides a high-level view of a typical process that is undertaken when an INE user 701 downloads a Web Page from an origin server 702. The Web Page typically is not downloaded in one shot. The user's 701 request for the Web Page 703 first travels to an ISP 704, which in turn forwards it through the Internet 705 to the origin server 702. The origin server 702 may return a main file for the Web Page (typically an HTML file) which contains embedded HTTP requests (i.e., Embedded Object Requests) for additional/other content (e.g., images, JavaScript code, HTML frames to be displayed within the Web Page). The Embedded Object Requests may or may not be destined to the same origin server 702. The initial response from the origin server 702 travels through the Internet to the ISP 706, and the ISP in turn forwards the response 707 to the INE user 701. The INE user's web-browser parses the file received from the origin server. If the file contains any Embedded Object Requests then the web-browser will initiate a secondary set of HTTP requests 708 that correspond to the Embedded Object Requests. Each of the secondary HTTP requests goes through a similar process as the one described for the initial/primary request. The web-browser subsequently receives HTTP responses 709 to the secondary HTTP requests 708. Some of the secondary HTTP responses 709 may themselves contain Embedded Object Requests, which in turn may result in the initiation of a third round of HTTP requests. Therefore, the process of downloading a Web Page can be recursive, and in theory one can design a Web Page that is infinitely recursive.

### Custom Toolbars for Web Browsers

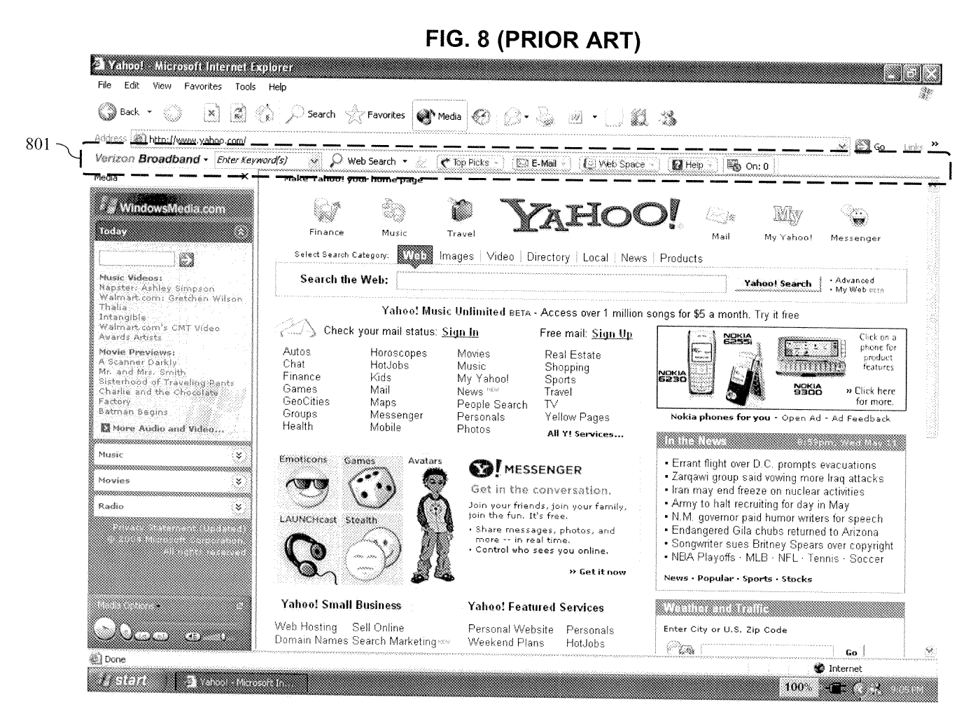

Custom Toolbars for Web Browsers are typically used by web content/service providers to provide their content/services in an “always-on” fashion, and separately from the requested web page presented to the user. FIG. 8 shows VERIZON BROADBAND's (service marks) implementation of a toolbar 801. YAHOO is another content/service provider that offers a custom toolbar for web browsers. A custom toolbar for web browsers may be introduced to the web browser, typically as an add-on, through a software download/installation. This technology is currently available for at least the MICROSOFT INTERNET EXPLORER and MOZILLA FIREFOX web browsers. In recent years, Internet portals have increasingly relied on custom third-party toolbars to provide quick to access to their services for their online users. An INE may provide its own custom toolbar for web browsers through a client-side software download/installation (i.e., via Method B described above).

### Internet Content Adaptation Protocol

HTTP Request modifications and HTTP Response modifications can be implemented using the Internet Content Adaptation Protocol (ICAP). ICAP is an existing open standard protocol for content adaptation. ICAP is intended to allow web proxy servers to alter HTTP requests and HTTP (server) responses at the point where these messages move through the proxy server. Accordingly, ICAP is typically used at the network edge. ICAP applications can include virus scanning and protection, fixed-banner advertisement insertion, child-protection filtering, wireless device support on plain websites, and language translation services, and the like. There are at least two widely available proxy servers that are ICAP-capable: the squid proxy server and the Shweby proxy server. ICAP may also be implemented using Twisted, an event-driven networking engine written in Python.

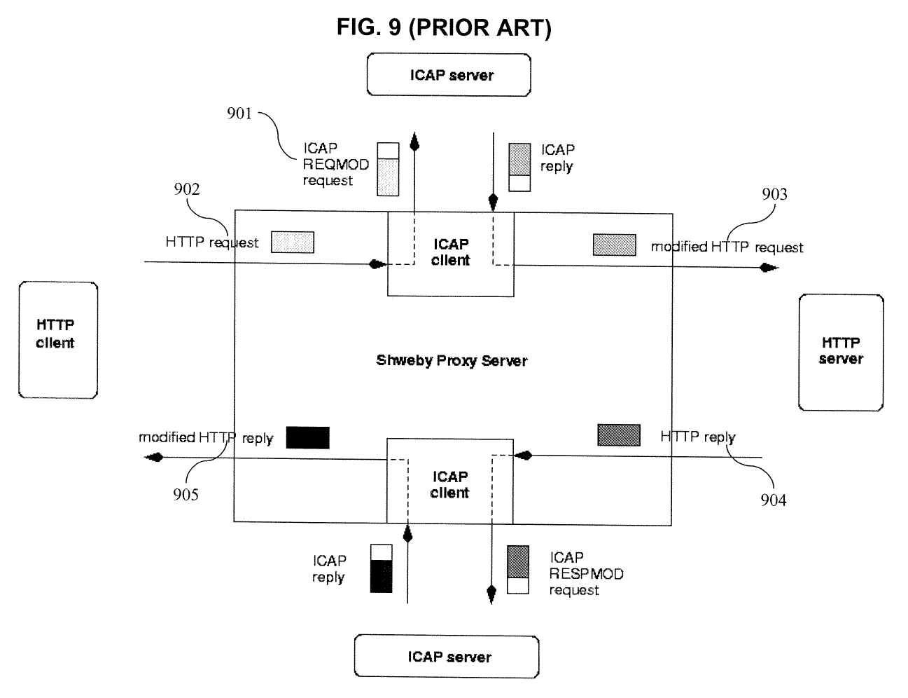

FIG. 9 shows the enhancement of the architecture of the Shweby proxy server to support ICAP. There are at least two main modes of ICAP operation. The first is REQMOD (REQuest MODification) 901, whereby before an HTTP request 902 is sent out to the intended (origin) web server, it is modified by an ICAP server 906, and a modified HTTP request 903 is instead sent out to Internet. If a proxy server 907 supports caching, then the HTTP request 902 may be modified pre-caching (i.e., while on its way into cache), or post-caching (i.e., on its way out of the cache). A second version of REQMOD is virtual request modification, which entails having the proxy server 907 supply an HTTP response for the HTTP request, without forwarding the HTTP request to another web server. A second main mode of ICAP operation is RESPMOD (RESPonse MODification), whereby an HTTP response 904 from the web server is modified by the ICAP server before a modified HTTP response 905 is sent back the user's web browser. Similar to HTTP request modification, HTTP response modification may occur before the HTTP response is cached, or on the response's way out of the cache heading back to the user's web browser.

### Transport Layer Security

Transport Layer Security (TLS) and its predecessor, Secure Sockets Layer (SSL), are cryptographic protocols that provide secure communications on the Internet for such things as web browsing, e-mail, Internet faxing, instant messaging and other data transfers. There are slight differences between SSL and TLS, but the protocol remains substantially the same.

The TLS/SSL protocol uses a pair of cryptographic keys: a public key and a private key. While the private key is kept secret, the public key may be widely distributed. The keys are related mathematically, but the private key cannot be practically derived from the public key. There are two important aspect of using public/private keys:
1) Security: A message encrypted with the recipient's public key cannot be decrypted by anyone except the recipient possessing the corresponding private key.
2) Authentication: A message signed (encrypted) with the sender's private key can be verified by anyone who has access to the sender's public key, thereby proving the identity of the sender.

The TLS/SSL protocol works as follows: First, the client sends a Hello Request to the server. The server responds with the server “Hello” message, followed by a certificate, followed by a “Hello Done” message. The certificate includes the following: 1) The name of the server as expected by a client e.g., www.mybank.com, which is also known as the common name (the common name must exactly match the name of the site requested by the client, 2) the server's public key, and 3) a special hash of the common name and the public key known as the md5 hash, signed (encrypted) with the private key of a trusted authority e.g., VERISIGN. The hash can be decrypted only using the public key of the trusted authority and upon successful decryption provides a proof of the server's identity (per the trusted authority). Trusted authorities are typically pre-installed on the web browser.

Upon receiving the certificate from the server, the client authenticates the identity of the server by checking whether the signature matches the information provided in the certificate. This is done using the public key of the trusted authority. Then the client sends its public key and a “FIN” message, to which the server responds with a “FIN” message too. After that, encrypted data (e.g., HTTP request/response) can be exchanged as the TLS/SSL data. After the data exchange, the connection is closed using CLOSE messages on both sides.

Various aspects of the present invention that enable an Intermediate Network Entity (INE) to modify or cause the modification of a Web Page requested a user and/or place INE content in a web browser are described below. In some aspects of the present invention, the modification of the requested Web Page and/or placing INE content into a web browser involves placing a toolbar in a designated area of the requested Web Page and/or within a web browser. In other aspects of the invention, the modification of the requested Web Page and/or placing INE content in to a web browser involves placing interstitial web content prior to and/or along with rendering of the requested web content using a variety of methods. Some of these methods are described in detail below. However, it will be appreciated that the various aspects of the present invention can be implemented in several other ways without deviating from the spirit of the present invention and all such methods are intended to be with in the scope of the present invention.

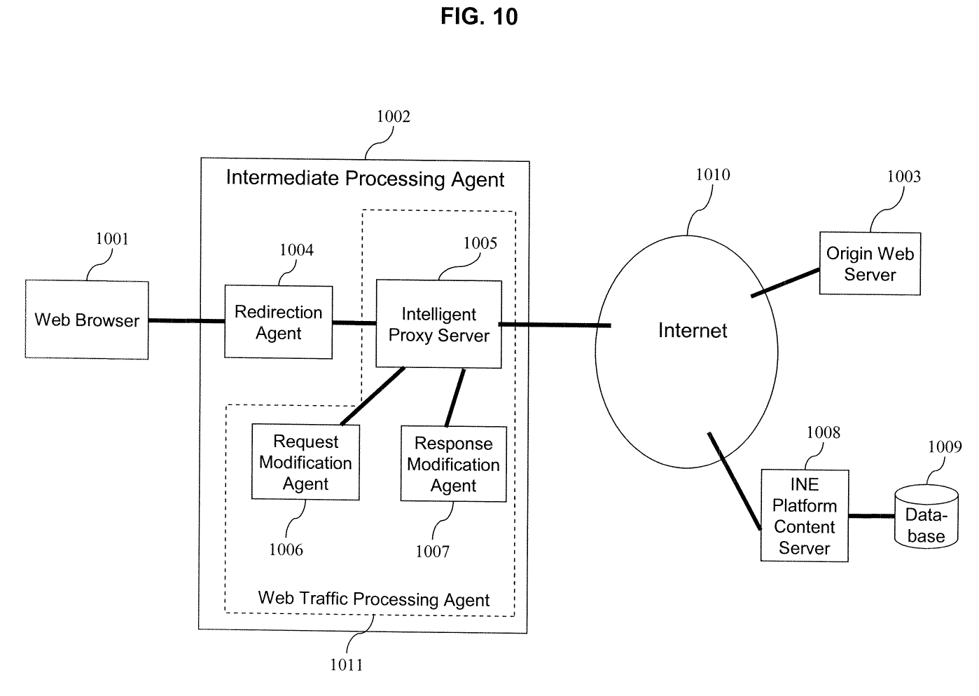

FIG. 10 illustrates one possible software architecture for carrying out an aspect of the invention (Method A). The implementation of Method A for the web browsing application may leverage ICAP. This general architecture is modular and may be specialized based on the properties of the web browsing application 1001 being used. The architecture can adapt to different web browsers (INTERNET EXPLORER, FIREFOX, etc.) and different scripting languages (HTML, JavaScript, etc.). One aspect of the software architecture is an intermediate processing agent 1002, which can be located anywhere between a web browser 1001 and the Internet 1010, and is operationally coupled to an INE. For this application, the intermediate processing agent 1002 is intended to mean a logical entity that can be implemented in software, or in hardware, or in a combination of software and hardware, whose purpose is to process requests from the web browser and/or responses to the web browser. The intermediate processing agent is also described using the term middleware module or middleware agent at times or in some places in this application and they intend to mean the same. The intermediate processing agent 1002 may reside on the edge router of the INE responsible for establishing the INE platform. In one instance, the intermediate processing agent 1002 may reside on the edge-router of the 1st order client ISP (304 in FIG. 3). The intermediate processing agent 1002 can create and maintain the INE platform, and includes at least the following components: a redirection agent 1004 and a web traffic processing agent 1011. The web traffic processing agent 1011 in turn can have the following components: an intelligent proxy server 1005, a request modification agent 1006, and a response modification agent 1007. The intermediate processing agent may include other components and/or intelligence that perform(s) software and/or hardware functions not performed by the redirection agent 1004 and/or the web traffic processing agent 1011.

The redirection agent 1004 may redirect certain IP datagrams received from the web browsing application 1001 to the web traffic processing agent 1011. Redirected IP datagrams may contain requests including but not limited to HTTP requests and HTTPS requests (HTTPS is HTTP over TLS/SSL.) There are at least two methods for redirecting IP datagrams. The first method relies on redirecting them based on the port number for that data stream. Port 80 and Port 8080 are the typical ports used when a web browser makes an HTTP request to a web server. Port 443 is the port typically used when a web browser makes an HTTPS request. In some examples, the Linux-based packet filtering tool, iptables, may be used to redirect IP datagrams based on the port number. However, not all HTTP requests use Port 80 or 8080, and not all HTTPS requests use Port 443. The second redirection method may involve peeking into a header of an IP datagram, which contains information about the protocol being used in the communication between the client and the server. If the protocol used indicates that the communication is for a web browsing client-server application, then the IP datagram may be redirected.

In some embodiments, the IP datagrams can be redirected to the intelligent proxy server 1005. As mentioned above, a proxy server typically re-initiates requests on behalf of the client and passes the corresponding response to the client. However, the intelligent proxy server 1005 can first redirect a request to the request modification agent 1006. The request modification agent 1006 can modify the header in the HTTP requests, before returning the modified request to the intelligent proxy server 1005, which can then send the modified request to the appropriate web server. Upon receiving the response corresponding to the modified request, the intelligent proxy server 1005 may forward that response to the response modification agent 1007. The response modification agent 1007 may add to, delete from, modify, or completely replace the content and/or the header of the response; and subsequently return the intermediate processing agent-processed (IPA-processed) response to the proxy server 1005. The intelligent proxy server 1005 may then forward the IPA-processed response to the web browsing application 1001. The request modification agent 1006 and the response modification agent 1007, along with their interaction with the intelligent proxy server 1005, may be implemented based on the Internet Content Adaptation Protocol. Indeed, the combination of the intelligent proxy server 1005, the request modification agent 1006, and the response modification agent 1007 may be implemented using the Squid proxy server with ICAP configuration, the Shweby proxy server with ICAP configuration, or using Twisted, an event-driven networking engine within Python. The intelligent proxy server 1005 can also provide flexibility to either cache content for faster operation or not cache content at all.

In some examples, the INE platform content server 1008 serves the content offered by the INE for the INE platform. A database 1009 stores user profile information and any state information required for maintaining, controlling and operating the INE platform. A web server 1003 may be a generic web server that returns content based on the HTTP request it receives. In a general case the INE platform content server 1008 and the database 1009 communicate over the Internet. However, it is also possible that the intermediate processing agent 1002, the INE platform content server 1008 and the database 1009 are on the same local area network, the same wide area network, or the same computer.

Three exemplary approaches are described for implementing a web browser INE platform following the concept of Method A. One exemplary approach, Approach 1, implements an INE platform in the form of a toolbar as shown in FIG. 5 (503). Another exemplary approach, Approach 2, is a method for implementing an INE platform in the form shown in FIG. 5 (503). In yet another approach (Approach 3) an INE platform in the form of one or more interstitial web content (e.g., web page) can be implemented. Interstitial web pages are web content and/or web pages that can be displayed before an expected content web page and/or content is displayed to a user.

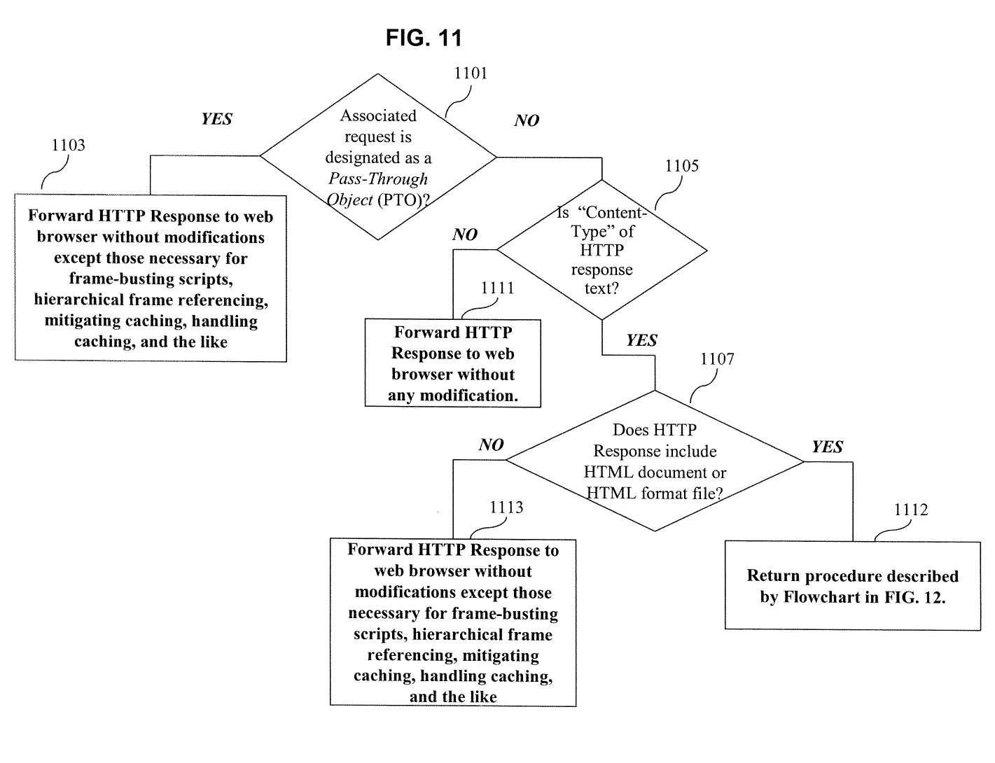

Reference will now be made to FIG. 11, which describes Approach 1 in more detail. FIG. 11 depicts a flowchart that describes one exemplary way that HTTP responses may be handled. First, a decision 1101 may be made to determine whether a request associated with the HTTP response (an HTTP request which resulted in fetching the said HTTP response) is designated as a Pass-Through Object (PTO). (The designation PTO is described later).

If the request associated with the HTTP response is designated as a PTO then a two-step action 1103 can be performed. First, the HTTP response can be forwarded to the web browser without any modification. There are possibly some exceptions including but not limited to: 1) Making modifications pertaining to neutralizing frame-busting scripts. The details are described in the co-pending patent application (Ser. No. 11/129,476). 2) Making modifications pertaining to maintaining hierarchical frame referencing. For example should the HTTP response contain a JavaScript procedure that references an object in another frame by using hierarchical referencing that starts with “top.”, then “top.” may be replaced with “top.requestedcontent.” where “requestedcontent” is the name given to the frame that contains the web page requested by the user or the web browser. 3) For the purpose of reducing the likelihood of content-caching by web browser, include one or more directives in the cache-control response header field that include but are not limited to: “no-store”, “no-cache”, “max-age=0”, “must-revalidate”, and “proxy-revalidate”. 4) For the purpose of reducing the likelihood of content-caching by web browser, include one or more meta tags in the response body that include but are not limited to: “no-store”, “no-cache”, “max-age=0”, “must-revalidate”, and “proxy-revalidate”. 5) For the purpose of reducing the likelihood of browser security-based disruption of inter-frame/inter-domain communication/referencing, set the domain name of the response the most general yet acceptable domain name e.g., if the URI corresponding to the response is ads.cnn.com, then the domain name may be set to cnn.com. 6) For the purpose of processing AJAX responses that may be generated by AJAX requests in the HTTP response, the URI in the “.open” function/method corresponding to an AJAX request, A-URI, may be flagged to allow the intermediate processing agent to recognize the corresponding response as an AJAX response, and possibly allow it to pass through. One possible way of flagging A-URI is to append it with a suffix that indicates that is a URI for an AJAX request. The concept of flagging URIs with suffices is discussed in co-pending non-provisional application (Ser. No. 11/129,476), and also in more detail below.

If the request associated with the HTTP response is not designated as a PTO, then another decision 1105 can be made to determine whether the content type of the HTTP response is text. If it is not text, then it may be an embedded object or a pure media object, in which case action 1111 can be taken to forward the HTTP response to the web browser without any modification. If it is text, then another decision 1107 can be made to determine if the content in the HTTP response is an HTML document or an HTML format file. One possible way to help make that determination can be to check whether the content in HTTP response contains <HTML> and <BODY> tags. Another possible way to help make that determination can be to compare the URI corresponding to the HTTP response to the URIs of well-known text-based HTML files such as www.cnn.com and www.yahoo.com. Other more sophisticated tests may also be used. If the content in the HTTP response is not an HTML document or an HTML format file, then Action 1112 can be taken to have the response modification agent 1007 send a procedure in place of the HTML document or HTML format file. The procedure may determine, among other things, whether the content of the HTTP response was intended to be displayed within a frameset, and, if so, some characteristics about that frameset. Such information can be used to eventually present the content of the replaced HTTP response to the user in an orderly fashion. The procedure can be written using several programming languages including but not limited to: JavaScript and VBScript. It may also be possible to write it using Java or ActionScript. For the purposes of this description and for the sake of simplifying it, the procedure is described using a JavaScript procedure as an example. It will be appreciated by those skilled in the art that the procedure may also be described using a VBScript procedure as an example.

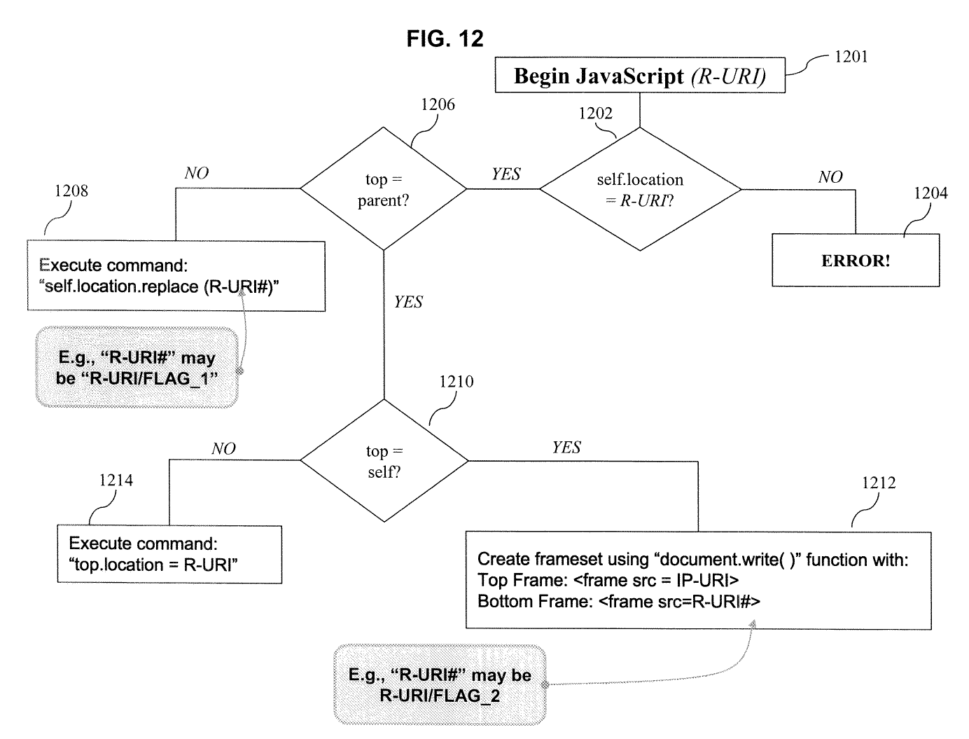

One embodiment of a JavaScript procedure is shown as a flow a chart in FIG. 12. If a determination is made that the content in the HTTP response is not an HTML document or an HTML format file, then the HTTP response can be forwarded to the web browser without any substantial modification 1213, with possible exceptions that include but are not limited to:
1) Adding directives, such as “no-store” and “no-cache”, to response header to reduce likelihood of caching by web browser (see above);
2) Adding meta tags, such as “no-store” and “no-cache”, in the response body to reduce likelihood of caching by web browser (see above);
3) Making modifications pertaining to neutralizing frame-busting scripts (see above); and
4) Making modifications pertaining to maintaining hierarchical frame referencing (see above).
5) Making modifications pertaining to facilitating inter-frame/inter-domain communication/referencing (see above).
6) Making modifications pertaining AJAX-generated requests (see above).

Referring to FIG. 12, the process of FIG. 12 can start with a step 1201 wherein the aforementioned JavaScript procedure can use R-URI (URI in the request associated with the HTTP response that was replaced with the JavaScript procedure) as an input. At step 1202, a precautionary decision can be made to test whether R-URI matches the “self.location” property of the frame in which the procedure is executing. The matching of self.location and R-URI can be a soft matching to allow for insignificant and/or inconsequential differences including but not limited to changes in timestamps. The outcome of the test may be expected to always be a match. However, if there is not a match, then an error 1204 can be declared, allowing for an appropriate error-handling action to be taken. Pursuant to a match, a decision 1206 can be made to determine whether the property “top” of the frame in which the JavaScript procedure is executing is equal to that frame's property “parent”. If there is no equality, this may imply that the said frame is a simple frame or a nested frame within the web page that the user requested. The term “native frame” will henceforth be used to denote a simple frame, an inline frame (i-frame), or a nested frame (e.g., a frame or an i-frame within a frame or an i-frame) within the web page that the user requested. If the frame in which the procedure is executing is a native frame, then the content that was originally intended for the said frame can be reloaded in order to display properly within the frame. One possible method for reloading the content is to first flag R-URI. For the purposes of this description, “#” will be used to indicate that a URI is flagged. Therefore, R-URI# denotes that R-URI had been flagged. It is important to note however that “#” does not imply that the URI is flagged in exactly the same manner each time. One possible way of flagging R-URI in this case is to append it with a suffix that indicates that the finding of the decision 1206 is no equality. The concept of flagging R-URI with suffices is discussed in co-pending non-provisional application (Ser. No. 11/129,476). Assuming R-URI is flagged by appending the suffix “FLAG 1”, the suffix can be appended in at least the following two manners: 1) R-URI/FLAG_{—}1 (this method can be used when R-URI does not end in a filename) 2) R-URI?FLAG=1 (or use “&” instead of “?” is R-URI already includes parameters). After flagging R-URI, the action “self.location.replace (R-URI#)” 1208 can be taken.

If the finding of the decision 1206 is that there is equality, then another decision 1210 can be made to determine whether the property “top” of the frame in which the JavaScript procedure is executing is equal to that frame's property “self”. If there is no equality this may imply that the INE platform exists and that the said frame corresponds to the area 502 i.e., the area designated to contain the web pages requested by the end user. For the purposes of this description, in this case the frame is referred to as the “main content frame”. If the procedure is executing in the main content frame, then the URI address box in the web browser can be updated to correctly reflect the address of the web page that the user requested, while preserving the presence of the INE platform. Action 1214, of executing the command “top.location=R-URI”, can be taken to accomplish that goal. If the outcome of the determination 1210 is equality, this may imply that the INE platform does not exist in the web browser. One possible method for creating the INE platform and presenting the content requested by the user is to take the action 1212 which is to use the function “document.write” to create a frameset with two frames. The top frame is the INE platform, whose content's URI will for the purpose of this description be denoted by “IP-URI”. (IP stands INE Platform). The bottom frame contains the content corresponding to the address R-URI. The intermediate processing agent 1002 can be informed that R-URI is requested as part of the construction of the INE platform, by flagging R-URI accordingly. If flagging is performed by appending a suffix, then it may be helpful if the suffix is different from the previous suffix. For example the suffix in this case can be appended in the manner “R-URI?FLAG=2”. A special parameter can be added to R-URI, whereby the value of the parameter is a random string (e.g., R-URI?FLAG=2&SPECIALPARAM=98237421). The special parameter and its random value can increase the likelihood that web browser will not rely on cached content to provide the content corresponding to R-URI. It will be appreciated that the randomness can be incorporated into the flagging itself, while preserving the message in the flagging to the intermediate processing agent 1002 (e.g., R-URI?FLAG=2_{—}98237421).

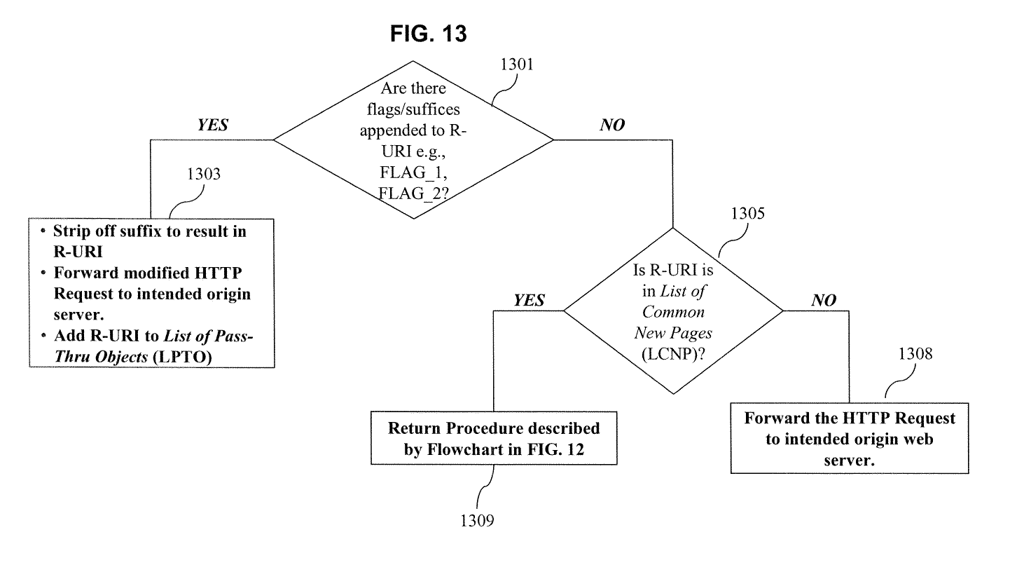

FIG. 13 describes one exemplary way of how the intermediate processing agent 1002 handles HTTP requests under Approach 1. First, a decision 1301 can be made to determine if the URI in an HTTP request is flagged (and/or contains a random string generated by the procedure). If it is flagged, then the action 1303 can be taken to perform the following three steps: 1) Remove the flagging and/or random string from the URI to render “R-URI”, 2) Forward the modified HTTP Request to the intended origin web server, and 3) designate “R-URI” as a pass-through object (PTO). Designating an HTTP request as a PTO can involve 1) placing the URI in the HTTP request in a special list, 2) waiting for an HTTP response whose URI matches the URI in the special list (with the matching process accounting for any flagging that may have been removed), 3) allowing the HTTP response to pass through, and 4) removing the URI from the special list. Alternatively, and potentially preferably, designating an HTTP request as a PTO can involve 1) monitoring the connection to the origin web server, established by the HTTP request, 2) awaiting the HTTP response corresponding to the HTTP request designated as a PTO, 3) receiving the HTTP response corresponding to the HTTP request designated as a PTO, and 4) allowing the corresponding HTTP response to pass through. If the URI is not flagged, then a second a decision 1305 can be made about the URI in the HTTP Request, “R-URI”. The said decision determines whether R-URI is in the List of Common New Pages (LCNP). The LCNP is created off-line and includes well-known web pages, that are delivered to web browsers as HTML documents or HTML format files, including but not limited to www.yahoo.com and www.cnn.com. If R-URI is in the LCNP then this may imply that its corresponding HTTP Response would be known a priori to be an HTML document or an HTML format file. In that case, the action 1309 can be taken to send the procedure described in FIG. 12 to the web browser as a response to the web browser's HTTP request. If R-URI is not in the LCNP, then the HTTP Request can simply be forwarded to its intended origin web server 1308. The corresponding response can subsequently be processed per FIG. 11. In Approach 1, whenever an HTTP request is forwarded to an origin server, the request modification agent 1006 can be used to disable the “If-Modified-Since:” field in the HTTP request header, if it exists. This action helps in forcing the origin web server to return a response, instead of relying on the web browser cache. The “If-Modified-Since” field can be disabled by at least two methods: 1) deleting the field from the HTTP request header, and 2) setting the date associated with the field to a sufficiently old date e.g., “Fri, 1 Jan. 1970 00:00:00 GMT”.

Reference will now be made to FIG. 10 to describe an exemplary way of implementing certain aspects of the invention based on Approach 2. HTTP responses can be handled by the intermediate processing agent 1002. The HTTP response may simply be a redirection directive, which can instruct the web browser to request another web page. The redirection directive can be implemented by using the “Location” field in the HTTP response header. Upon receiving an HTTP response, the intermediate processing agent 1002 can inspect whether the URI corresponding to the HTTP response is in the Redirect List (RDL). (The population of RDL is described later.) If the URI is in RDL, then the URI can be removed from RDL. Next, the HTTP response's header can be inspected to see if it has a “Location” field. If it does then 1) the new URI in the Location field “N-URI” can be added to RDL, and 2) It can be determined whether the URI corresponding to the HTTP response is the value of the variable NEWURI. (The assignment of values to NEWURI is explained later). If the URI corresponding to the HTTP response is the value of the variable NEWURI, then the variable NEWURI can be reassigned to N-URI. The task of adding URIs to and removing URIs from RDL and/or the task of updating the value of NEWURI may be improved by 1) monitoring the connection to an origin web server, established by an HTTP request generated in response to a redirection directive, 2) adding the URI in the HTTP request to RDL, 3) receiving an HTTP response corresponding to the HTTP request, 4) removing the URI from RDL, and 5) updating NEWURI based on the HTTP response.

If the HTTP response's header does not have a “Location” field then it can be determined whether the URI corresponding to the HTTP response is in RDL and is the current value of the variable NEWURI. If the URI corresponding to the HTTP response is in RDL and is the current value of the variable NEWURI, then the response modification agent 1007 can be used to return a procedure to the web browser and the procedure can execute in the web browser. The procedure can be written using several programming languages including but not limited to: JavaScript and VBScript. It may also be possible to write it using Java or ActionScript. For the purposes of this description and for the sake of simplifying it, the procedure is described using a JavaScript procedure as an example. It will be appreciated by those skilled in the art that the procedure may also be described using a VBScript procedure as an example. The JavaScript procedure can perform the command “top.location.replace(N-URI)”.

If the HTTP response does not have a “Location” field and either one of the following is true: 1) The URI corresponding to the HTTP response is not in RDL or 2) The value of NEWURI is not the URI corresponding to the HTTP response is not in RDL, then the response modification agent 1007 can be used to modify an HTTP response in several ways, including but not limited to:
1) Adding directives, such as “no-store” and “no-cache”, to response header to reduce likelihood of caching by web browser (see above);
2) Adding meta tags, such as “no-store” and “no-cache”, in the response body to reduce likelihood of caching by web browser (see above);
3) Making modifications pertaining to neutralizing frame-busting scripts (see above);
4) Making modification pertaining to maintaining hierarchical frame referencing (see above);
5) Making modifications pertaining to facilitating inter-frame/inter-domain communication/referencing (see above).
6) Making modifications pertaining AJAX-generated requests (see above).
7) Flagging URIs for Embedded Object Requests such that when web browser eventually issues them they are identified to the intermediate processing agent as Embedded Object Requests. Possible ways for flagging them include but are not limited to:
   a) Appending the suffix “?EO=ON” (or use “&” instead of “?” if the URI for the Embedded Object Request already includes parameters); and
   b) Appending the suffix “/EO”;
8) Flagging URIs for potential Embedded Link Requests such that when corresponding HTTP requests are issued, they are identified to the intermediate processing agent as HTTP requests for Embedded Links. Possible ways for flagging them include but are not limited to:
   a) Appending the suffix “?EL=ON” (or use “&” instead of “?” if the URI for the Embedded Object Request already includes parameters);
   b) Appending the suffix “/EL”.

If the HTTP response is a non-text file then the intermediate processing agent 1002 can forward it to the web browser without any modifications to the body of the HTTP response.

In Approach 2, whenever an HTTP request is forwarded to an origin server, the request modification agent 1006 can be used to disable the “If-Modified-Since:” field in the HTTP request header, if it exists. This action can enable in forcing the origin web server to return a response, instead of relying on the web browser cache. The “If-Modified-Since” field can be disabled by at least two methods: 1) deleting the field from the HTTP request header, and 2) setting the date associated with the field to a sufficiently old date e.g., “Fri, 1 Jan. 1970 00:00:00 GMT”. If the intermediate processing agent 1002 receives a HTTP request with a flagged URI, “R-URI#”, whereby the flagging indicates that the HTTP request is an Embedded Object Request, the request modification agent 1006 can remove the flag and the intelligent proxy server 1005 can forward the restored/unflagged URI, “R-URI”, to the intended origin web server. If the intermediate processing agent 1002 receives a HTTP request with a flagged URI, “R-URI#”, whereby the flagging indicates that the HTTP request corresponds to an Embedded Link Request, request modification agent 1006 can return an HTTP response to the web browser, whereby the HTTP response can contain an HTML document that contains a procedure. The procedure can be written using several programming languages including but not limited to: JavaScript and VBScript. It may also be possible to write it using Java or ActionScript. For the purposes of this description and for the sake of simplifying it, the procedure is described using a JavaScript procedure as an example. It will be appreciated by those skilled in the art that the procedure may also be described using a VBScript procedure as an example.

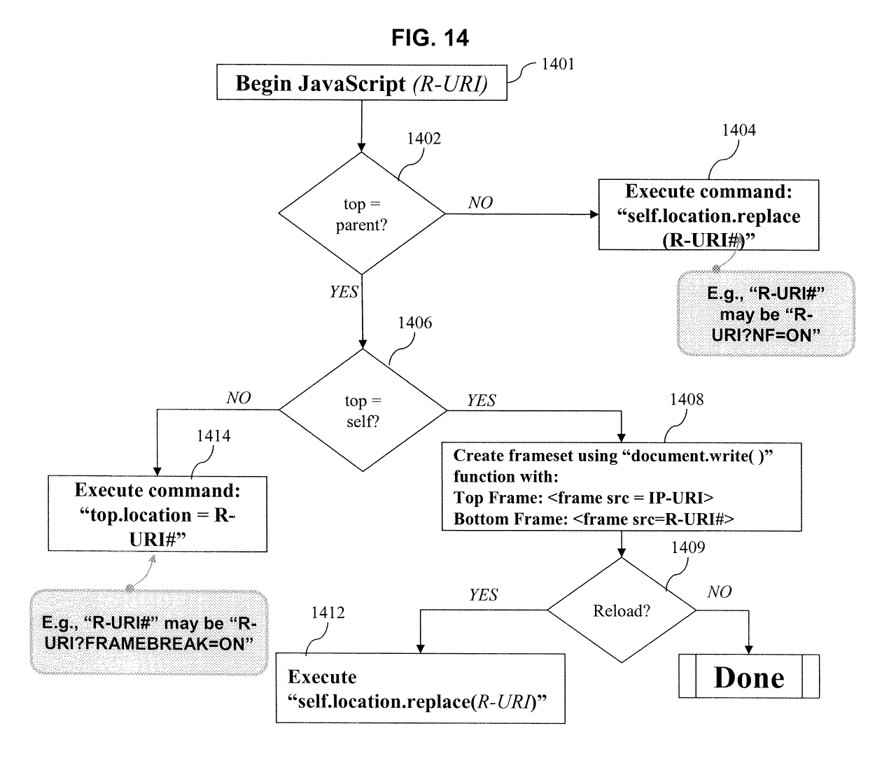

A flowchart of one embodiment for such a JavaScript procedure is shown in FIG. 14. The procedure described in FIG. 14 can take as input “R-URI” 1401. “R-URI” corresponds to the URI of the Embedded Link Request without the flag. First a decision 1402 can be made to determine whether the frame in which it is executing is a native frame within the web page that the user/web browser requested. If the frame is a native frame, then the procedure can simply take the action 1404 of executing the command “self.location.replace(R-URI#)” whereby the flagging indicates to the intermediate processing agent 1002 that the HTTP response corresponding to R-URI will be displayed in a native frame within the requested web page. R-URI can be flagged in several ways including but not limited to appending the suffix “?NF=ON”. The intermediate processing agent 1002 can use a mechanism similar or identical to the PTO mechanism used in Approach 1 to forward the eventual corresponding HTTP response to the web browser 1001 without any modifications with possible exceptions that include but are not limited to:
1) Adding directives, such as “no-store” and “no-cache”, to response header to reduce likelihood of caching by web browser (see above);
2) Adding meta tags, such as “no-store” and “no-cache”, in the response body to reduce likelihood of caching by web browser (see above);
3) Making modifications pertaining to neutralizing frame-busting scripts (see above); and
4) Making modification pertaining to maintaining hierarchical frame referencing (see above).
5) Making modifications pertaining to facilitating inter-frame/inter-domain communication/referencing (see above).
6) Making modifications pertaining AJAX-generated requests (see above).

If the frame in which the procedure is executing is not a native frame, (with the implicit assumption that if there is a top-level frameset in the web browser at that point then the top frame is INE platform), then a decision 1406 can be made to determine if the INE platform frame exists. If the property “top” is equal to the property “self” for the frame in which the procedure is executing, then this may imply that no frameset exists in the web browser, in which case the action 1408 can be taken to use the function “document.write” to create a frameset with two frames. The top frame is the INE platform, whose content's URI will for the purpose of this description be denoted by “IP-URI”. The bottom frame contains the content corresponding to the address R-URI. “R-URI” can be flagged to indicate to the intermediate processing agent 1002 the request being part of the construction of the frameset with the INE platform in the top frame. When the web browser subsequently issues the HTTP request containing R-URI#, the request modification agent 1006 can be used to restore “R-URI#” back to “R-URI”, which in turn can be forwarded to its intended origin web server 1003. Upon the completion of downloading the two frames to the web browser, the web browser can query the intermediate processing agent 1002 as to whether to reload R-URI to ensure correct presentation of the corresponding content to the user. The query, 1409, can be implemented using the “onload” event within the <frameset> tag (used to construct the two frames by action 1408). The “onload” event can be used to trigger the execution of a procedure that leverages the “XMLHttpRequest” object to send an HTTP request to the intermediate processing agent 1002, which in turn can return an HTTP response that indicates whether or not to reload. (One possible method for how the decision to reload can be made may be by using the LCEO and inspecting its size as explained below for the case when the intermediate processing agent 1002 receives an HTTP request with an unflagged URI.) If a reload is indicated, then it can be implemented by taking the action 1412 of executing the function “self.location.replace(R-URI)” or the function “top.location.replace(R-URI). If the outcome of the decision 1406 is that the INE frame exists, then action 1414 can be taken to break out of the current frameset, and to create a new frameset. One advantage of creating the new frameset is that “R-URI” can appear in the URI address box. The action 1414 can be taken by executing the function “top.location=R-URI#”, where the flagging indicates that R-URI is being requested as part of a breaking of the current frameset. The flagging can be implemented in several ways including but not limited to “R-URI?FRAMEBREAK=ON”.

If the intermediate processing agent 1002 receives an HTTP request with an unflagged URI, henceforth referred to as “R-URI”, then the intermediate processing agent 1002 may not be able to immediately determine the type of the HTTP request. There are several possible types, including but not limited to:
1) The HTTP request being generated by entering a URI in the web browser URI address box;
2) The user clicking on an unflagged Embedded Link; and
3) The web browser generating an HTTP request for an unflagged Embedded Object.

If the intermediate processing agent 1002 does indeed receive an unflagged URI, “R-URI”, then intermediate processing agent 1002 can:
1) Use the request modification agent 1006 to disable the “If-Modified-Since:” field in the HTTP request header, if it exists (see above). This action helps in forcing the origin web server to return a response, instead of relying on the web browser cache; and
2) Check if R-URI is in the Redirect List (RDL). (The creation of RDL is described earlier.) If R-URI is in RDL, then the request modification agent 1006 can forward the HTTP request to its intended Origin Web Server.

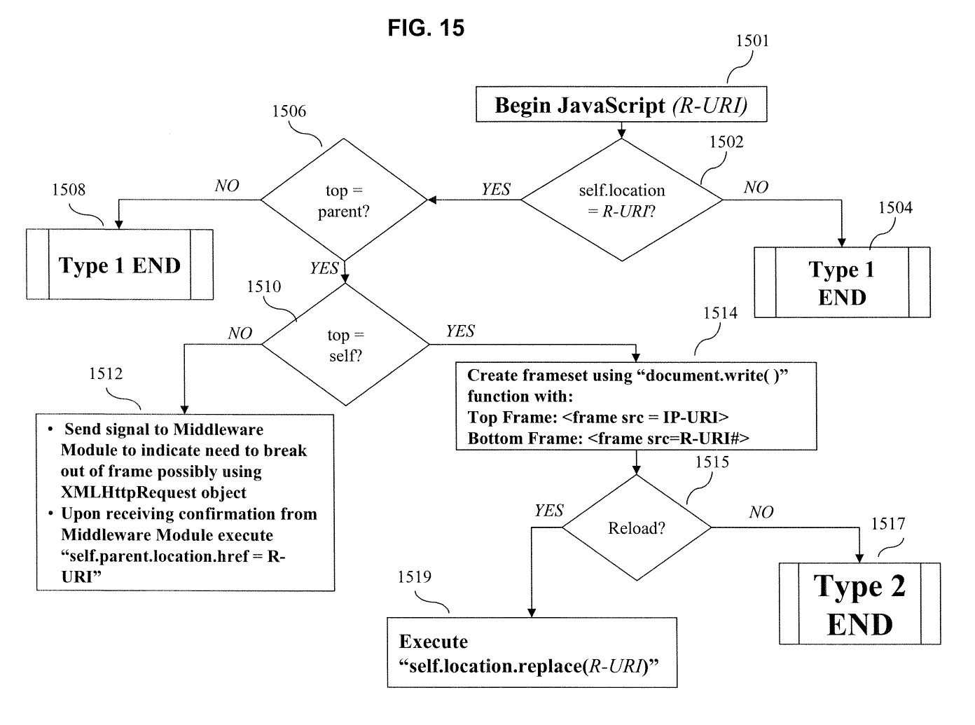

If “R-URI” is not in RDL, the request modification agent 1006 can check if R-URI is in the List of Common Embedded Objects (LCEO). (The creation of LCEO is described later.) If R-URI is in LCEO, then the intermediate processing agent 1002 can forward the HTTP request to its intended Origin Web Server. If “R-URI” is not in RDL and is not in LCEO, then the intermediate processing agent 1002 can check if R-URI is in the Reload List (RLL). (The creation of RLL is described later, but if a URI is in RLL then this can indicate that the corresponding web page had been delivered to the web browser, but some Embedded Objects are still missing from it, and may appear in the web page once the web page is reloaded). If R-URI is in RLL, then the intermediate processing agent 1002 can forward the HTTP request to its intended Origin Web Server 1006. If R-URI is not in RDL, is not in LCEO, and is not RLL then the intermediate processing agent 1002 can:
1) Add R-URI to LCEO;
2) Using the request modification agent 1006, return an HTTP Response containing a procedure to the web browser. The procedure can be written using several programming languages including but not limited to: JavaScript and VBScript. It may also be possible to write it using Java or ActionScript. For the purposes of this description and for the sake of simplifying it, the procedure is described using a JavaScript procedure as an example. It will be appreciated by those skilled in the art that the procedure may also be described using a VBScript procedure as an example. A flowchart for one such embodiment of a JavaScript procedure is shown in FIG. 15. The JavaScript procedure can execute in the web browser.

Referring to FIG. 15, if “R-URI” was generated by an unflagged Embedded Object, then the JavaScript procedure can take the path 1501, 1502, before ending at END 1504. (Ending at END 1504 may occur because the web browser cannot execute the procedure in place of the object it replaced). END 1504 technically can represent the end of the procedure, but reaching this point may not have achieved the desired result of displaying the Embedded Object. It may however be expected there will be a reload of the web page containing the Embedded Object which, given the updating of LCEO, can result in the correct display of the Embedded Object. If “R-URI” was generated for a native frame, then the JavaScript procedure can take the path 1501, 1502, 1506, before ending at END 1508. (Ending at end 1508 can occur because the web browser may not execute the procedure in place of the object it replaced). As with END 1504, pursuant to END 1508 a reload of the web page, containing the native frame, may be expected to result in a correct display of the native frame. If “R-URI” is generated by clicking on a link in the main content frame, then the JavaScript procedure can take the path 1501, 1502, 1506, 1510, before taking the action 1512. Action 1512 can consist of two steps:
1) Sending a signal to the intermediate processing agent 1002 indicating that the JavaScript procedure's execution in a main content frame. The signal can be sent using an “XMLHttpRequest” object to send an HTTP request to the intermediate processing agent 1002, whereby the URI in the HTTP request can be “R-URI#”, and the flagging can convey that the JavaScript procedure is executing in a main content frame. The flagging can be implemented by appending the suffix “/FRAMEBREAK” to R-URI in the “XMLHttpRequest” object. In turn, the intermediate processing agent 1002 can remove R-URI from LCEO and respond to the HTTP Request with “Done”; and
2) Upon receiving the response from the intermediate processing agent 1002, executing the command “self.parent.location.href=R-URI”.

If “R-URI” is generated by entering a URI in the URI address box, then the JavaScript procedure can take the path 1501, 1502, 1506, 1514, before reaching the decision 1515. Action 1512 can use the function “document.write” to create a frameset with two frames. The top frame is the INE platform, whose content's URI will for the purpose of this description be denoted by “IP-URI”. The bottom frame contains the content corresponding to the address R-URI. “R-URI” can be flagged to indicate to the middleware module/intermediate processing agent 1002 that it is requested as part of the construction of the frameset with the INE platform in the top frame. When the web browser subsequently issues the HTTP request containing R-URI#, the intermediate processing agent 1002 can 1) remove R-URI from the LCEO, 2) restore “R-URI#” back to “R-URI”, which in turn can be forwarded to its intended origin web server, and 3) save R-URI as the most recent new web page request. A variable NEWURI can be used to store R-URI. The decision 1515 can involve sending a query to the intermediate processing agent 1002 as to whether to perform a reload or not. The query can be implemented using the “onload” event within the <frameset> tag (used to construct the two frames in action 1514). The “onload” event can be used to trigger the execution of a procedure that leverages the “XMLHttpRequest” object to send an HTTP request to the intermediate processing agent 1002. The URI in the HTTP request can be “R-URI#”, whereby the flagging can convey the request's purpose of determining whether or not to reload. The flag can be implemented by appending the suffix “/RELOAD” to R-URI in the “XMLHttpRequest” object. The intermediate processing agent 1002 in turn can return an HTTP response that indicates whether or not to reload. The intermediate processing agent 1002 can make a determination about a reload by comparing the current size of LCEO to what it was just before processing the request for the new web page. If the list has grown, then a reload may be necessary. If a reload is not required, then the procedure can reach END 1517. If a reload is needed, then the action 1519 can be taken to perform the reload using the function “self.location.replace” or the function “top.location.replace” with the argument R-URI.

In both Approach 1 and Approach 2, IP-URI, the URI for the content of the INE platform, can be set to have the same domain name as the URI of the requested web page, R-URI. The IP-URI can be flagged in a particular way to indicate to the intermediate processing agent 1002 that it is the URI for the content of the INE platform. Using the redirection agent 1004 and/or the request modification agent 1006, the intermediate processing agent 1002 can forward the request to the INE Platform Content Server 1008. Setting the domain name of IP-URI to be the same as that of R-URI, may allow for more flexibility in terms of content and applications in the INE Platform, including as it pertains to communication/interaction between the INE Platform frame and the bottom frame containing the content corresponding to the address R-URI. Furthermore, in both Approach 1 and Approach 2, the command “top.document.title=self.document.title” can be used to set the title of the browser window to the title of web page/web content intended to be viewed in the “main content frame”, whereby the command is to be executed in the “main content frame”.

Dynamic content in the INE toolbar 503 may be such that it cannot be interrupted by the user's scrolling or navigating to other web pages, by maintaining the state of INE toolbar and/or its content in the intermediate processing agent 1002 and/or the INE Platform content server 1008.

In another aspect of the invention, a method for implementing an INE platform in the form of an interstitial web page/web content is described (Approach 3 for Method A). Interstitial web pages/web content are web pages that are displayed before an expected new web page is displayed in a web browser. At a high level, the response modification agent 1007 can be used to replace a new web page/web content whose URI is R-URI, with an interstitial web page/web content. The interstitial web page/web content can be implemented in such a way as to eventually proceed to the web page corresponding to the R-URI. There are several possible ways of implementing this concept, including but not limited to:
1) Having a counter in the interstitial web page/web content whereby at the end of the count, R-URI can automatically be requested as a new web page.
2) Having a button in the interstitial web page/web content whereby when a user clicks on it, R-URI can be requested as a new web page
3) Having an entry box in the interstitial web page/web content whereby a user can enter R-URI in it, which can cause R-URI to be requested as a new web page. The user can also enter any other URI, for which the corresponding web page can be requested.

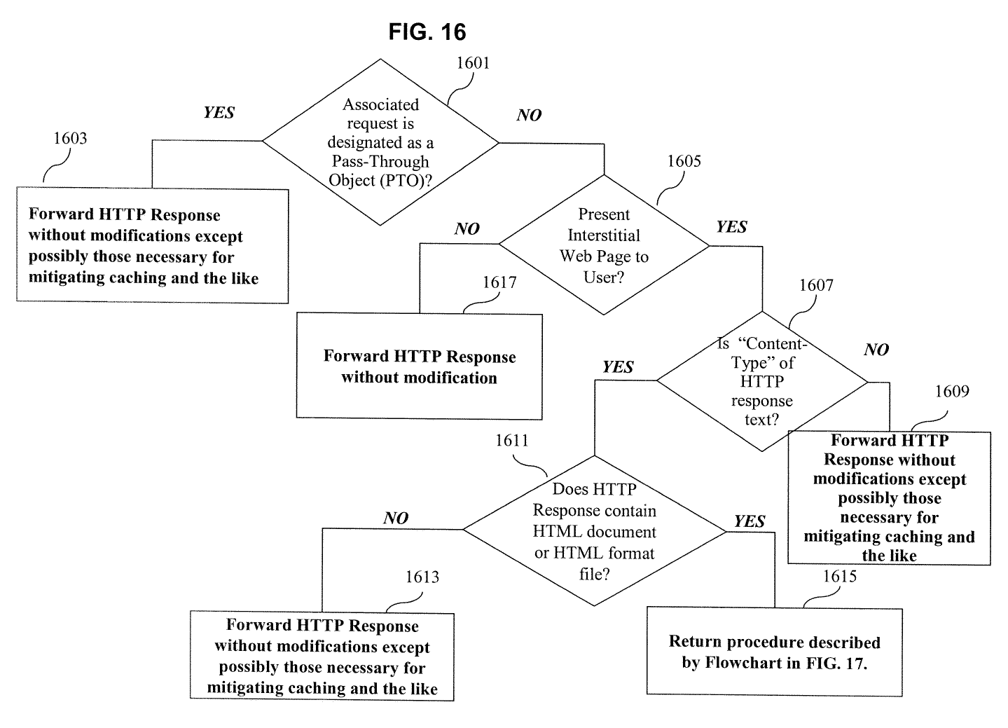

Reference will now be made to FIG. 16, which describes one exemplary method for rendering interstitial web page/web content to a web browser prior to rendering the requested web page/web content. FIG. 16 shows a flowchart that describes one possible way that HTTP responses can be handled. First, a determination 1601 can be made as to whether the HTTP response can be passed through to the web browser 1001 without modifications. This determination can be made using several methods, including but not limited to:
1) Examining whether the HTTP requests corresponding to the HTTP response is designated as a pass-through object (PTO).
2) Examining whether the URI sent by the web browser to fetch the said HTTP response was flagged accordingly.

If the HTTP response is deemed passable without any modifications, then it may indeed be passed through to the web browser 1001 without any modifications 1603, with the possible exception of making modifications pertaining to mitigation caching (see above). If the HTTP response is not designated to automatically pass through then another determination 1605 can be made regarding whether the user is to be presented with an Interstitial web page/web content. The determination as to whether to present an Interstitial web page/web content to the user can be based on several factors, including but not limited to:
1) The time elapsed since the last time an Interstitial web page/web content was presented to user.
2) The occurrence of an event that mandates the presenting of the Interstitial web page/web content to user. This event may for example be an emergency weather alert.

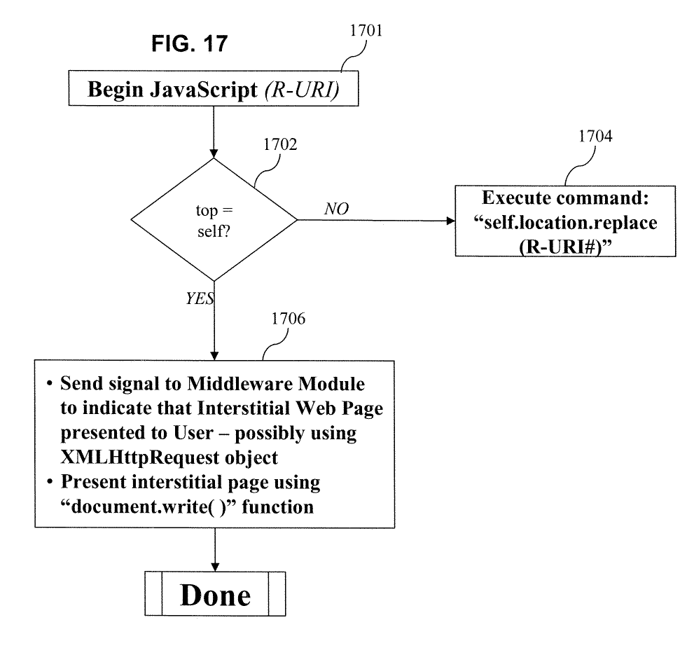

If the determination is not to present an Interstitial web page/web content to the user then the HTTP response can be forwarded to web browser without modification 1617. If the determination is to present an Interstitial web page/web content to the user then another determination 1607 can be made as to whether the content type of the HTTP response is text. If it is not text, then it may be an embedded object or a pure media object, in which case Action 1609 can be taken to forward the HTTP response to the web browser without any modification. If it is text then another decision 1611 can be made to determine if the content in the HTTP response is an HTML document or an HTML format file. One way to help make that determination can be to check whether the HTTP response contains <HTML> and <BODY> tags. Another way to help make that determination can be by comparing the URI corresponding to the HTTP response to the URIs of well-known text-based HTML files such as www.cnn.com and www.yahoo.com Other more sophisticated tests may also be used. If the content in the HTTP response is not an HTML document or an HTML format file, then the HTTP response can be forwarded to web browser 1001 without modification 1613 with possible exceptions that include but are not limited to: adding directives, such as “no-store” and “no-cache”, to response header to reduce likelihood of caching by web browser (see above). If the content in the HTTP response is not an HTML document or an HTML format file, then, using the response modification agent 1007, the intermediate processing agent 1002 can return a procedure to the web browser, whereby the procedure can execute in the web browser. The procedure can be written using several programming languages including but not limited to: JavaScript and VBScript. It may also be possible to write it using Java or ActionScript. For the purposes of this description and for the sake of simplifying it, the procedure is described using a JavaScript procedure as an example. It will be appreciated by those skilled in the art that the procedure may also be described using a VBScript procedure as an example. A flowchart for one embodiment of such JavaScript procedure is shown in FIG. 17.

Referring to FIG. 17, the procedure can take as input the URI corresponding to the replaced HTTP response, henceforth referred to as “R-URI” 1701. A determination 1702 can be made as to whether the frame in which the procedure is executing is a “top level frame” which can be viewed as equivalent to the main web browser window 505. If it is not a “top level frame”, then it may be a native frame. If it is not a “top level frame”, then the action 1704 can be taken to request the content originally intended for the native frame. The command “self.location.replace” can be used for this purpose. The argument in that command can be “R-URI” which further can be flagged to “R-URI#”, in order to indicate to the intermediate processing agent 1002 that when it receives the corresponding HTTP response it can let it pass through without modification. The intermediate processing agent 1002 can restore R-URI# to R-URI before forwarding R-URI to its intended origin web serve. The intermediate processing agent 1002 can also designate the HTTP request containing R-URI as a PTO. Designating an HTTP request as a PTO can involve 1) placing the URI in the HTTP request in a special list, 2) waiting for an HTTP response whose URI matches the URI in the special list (with the matching process accounting for any flagging that may have been removed), 3) allowing the HTTP response to pass through, and 4) removing the URI from the special list. Alternatively, and potentially preferably, designating an HTTP request as a PTO can involve 1) monitoring the connection to the origin web server, established by the HTTP request, 2) awaiting the HTTP response corresponding to the HTTP request designated as a PTO, 3) receiving the HTTP response corresponding to the HTTP request designated as a PTO, and 4) allowing the corresponding HTTP response to pass through. If the procedure is executing in a “top level frame”, then it can first send a signal 1706 to the intermediate processing agent 1002 that an Interstitial web page/web content is to be presented to the user. The “XMLHttpRequest” object can be used to send the signal by sending an HTTP request to the intermediate processing agent 1002 or the INE Platform content server 1008, which in turn can return an HTTP response that indicates acknowledgement. The intermediate processing agent 1002 can then update its state to reflect the presentation of an Interstitial web page/web content to the user. Second, the procedure can introduce the Interstitial web page/web content using the “document.write( )” function. The signal to the intermediate processing agent 1002, that an Interstitial web page/web content is to be presented to the user, can alternatively be generated by the interstitial web page/web content itself. The procedure can also introduce the Interstitial web page/web content using “self.location.replace(INTURI)”, where INTURI is the URI of the interstitial web page/web content. INTURI can be flagged to in a manner that communicates to the intermediate processing agent 1002, that the HTTP request containing it is for the interstitial web page/web content, and the intermediate processing agent 1002 can allow the corresponding HTTP response to pass through. INTURI can contain in its parameters R-URI. The Interstitial web page/web content can be designed to include one or more mechanisms for eventually taking the user to web page/web content that the user requested. There are several possibilities for such mechanisms, including but not limited to:
1) Having a counter in the interstitial web page/web content whereby at the end of the count, R-URI can automatically be requested as a new web page.
2) Having a button in the interstitial web page/web content whereby when a user clicks on it, R-URI can be requested as a new web page.
3) Having an entry box in the interstitial web page/web content whereby a user can enter R-URI in it, which can cause R-URI to be requested as a new web page. The user can also enter any other URI, for which the corresponding web page can be requested.

When an HTTP request is initiated by such a mechanism, the URI within it can be flagged to indicate the mechanism to the intermediate processing agent 1002. Approach 3 may be improved by making modifications pertaining AJAX-generated requests (see above) to 1) all HTTP responses, whose content is of type text, or 2) to some HTTP responses, whose content of of type text, that are forwarded to the web browser before the interstitial web page/web content is presented. The determination of which HTTP responses in (2) are modified may be based on several factors including but not limited to their time of receipt.

It may be desired to introduce interstitial content as early as possible. In another embodiment of presenting an interstitial web page/web content to a web browser, Approach 3 described above can be altered slightly, whereby decision 1702 is skipped, and step 1704 is executed using the command top.location.replace(INTURI), so that the interstitial web page/web content can be presented to a web browser, even when the web browser is not in the process of replacing the entire content for its “top level frame”.

In certain embodiment of the present invention, instead of or in addition to relying on the intermediate processing agent 1002 to maintain the state of the user regarding the history of presenting Interstitial web pages/web content to the user, one or more cookies can be employed to maintain the state. If cookies are employed, then a procedure executing in the web browser can inspect the cookies and based on their values determine whether to present an Interstitial web page/web content.

In another embodiment of presenting an Interstitial web page/web content to a web browser, the methods involve presentation of an Interstitial frameset whereby the top frame can contain content from the INE and the bottom frame can contain the web page/web content requested by the user. The construction of the frameset can be done using the “document.write( )” function within the JavaScript procedure whose flowchart is shown in FIG. 17. In the construction of the frameset, R-URI for the web page requested by the user can be flagged to indicate to the intermediate processing agent 1002 that it is being requested as part of the construction of an Interstitial frameset.

Approaches 1, 2 and 3 require the processing of responses, which in turn requires the ability to analyze content. However, if the web content is requested using HTTPS, then it will be encrypted using TLS/SSL cryptographic protocol. In that case, the response may need to be decrypted in order to be able to implement Approach 1, Approach 2 and/or Approach 3. In order to perform the decryption, the intermediate processing agent can be configured as a trusted authority on the web browser. Therefore, a certificate issued by the intermediate processing agent, for the intermediate processing agent, and signed by the intermediate processing agent (IPA-certificate) may need to be installed among the root certificates of the web browser. Installing the IPA-certificate can be done by providing the user with instructions through the INE platform.

The intermediate processing agent 1002 can then redirect all traffic on port 443 (HTTPS using TLS/SSL), via the redirection agent 1004. Upon receiving a request for a TLS/SSL handshake, the intermediate processing agent 1002 determines the common name of the intended origin web server for the HTTPS connection (origin HTTPS server). The common name can be obtained if the user sets the intermediate processing agent as the proxy server for the web browser. The common name can also be obtained by having the intermediate processing agent 1002 establish a separate TLS/SSL connection with the origin HTTPS server, and extracting the common name from the returned certificate. The intermediate processing agent 1002 can identify the origin HTTPS server, by consulting the redirection agent 1004. The redirection agent 1004 may store the IP address of the origin HTTPS server. The intermediate processing agent 1002 may also obtain the common name by performing a reverse IP lookup on the IP address of the origin HTTPS server.

The intermediate processing agent 1002 can construct a substitute certificate such that 1) the common name in the substitute certificate is set to the common name in the certificate from the origin HTTPS server, 2) the public key is set to the public key of the intermediate processing agent 1002 (here in the role of a web server), 3) the serial number of the certificate is assigned a valid value e.g., different serial numbers for different common names, and 4) the signing of the substitute certificate is done using the private key of the intermediate processing agent 1002 (here in the role of a trusted authority). The intermediate processing agent 1002 can return the substitute certificate to the web browser thus establishing a TLS/SSL connection with the web browser. Once a substitute certificate is constructed for a common name, it can be stored and used whenever a substitute certificate for the common name is required.

The intermediate processing agent can also obtain a valid substitute certificate by having a trusted authority (e.g., Verisign) generate a certificate, either offline or in real time, whereby the certificate can contain the required common name and the public key of the intermediate processing.

The intermediate processing agent 1002 can now decrypt the HTTP request, and connect to the intended origin HTTPS server using a separate TLS/SSL handshake. Hence, the intermediate processing agent 1002 can 1) decrypt the resulting HTTP response, 2) process it as required per Approach 1, Approach 2, and/or Approach 3, 3) encrypt the processed response per the TLS/SSL connection with the web browser, and 4) forward the encrypted response to the web browser as part of the established TLS/SSL connection.

The intermediate processing agent to can also modify HTTPS requests that are Link Requests or Embedded Object Requests in a response, such that the URI of the HTTPS request is replaced with a URI (TS-URI) containing the address of the intermediate processing agent 1002. TS-URI can contain information (e.g., in the form of URI parameters) about the original URI for the HTTPS request. Then a certificate for the intermediate processing agent, signed by a trusted authority (e.g., Verisign) can establish the TLS/SSL handshake between the web browser and the intermediate processing agent 1002. The intermediate processing agent can then 1) decrypt the HTTP request per the TLS/SSL connection established with the web browser, 2) connect to the origin HTTPS server using a separate TLS/SSL connection, 3) process the response received on the TLS/SSL connection with the origin HTTPS server, and 4) forward the processed response to the web browser over the TLS/SSL connection established with the web browser.

In Method B, the INE platform is introduced by installation and/or downloading software on the user's computer/device. This approach involves leveraging custom third-party toolbar technology. This technology is currently available for at least Internet Explorer and Firefox. In recent years, Internet portals have increasingly relied on custom third-party toolbars to provide quick to access to their services for their online users. FIG. 8 shows VERIZON BROADBAND's implementation of the toolbar 801. A custom INE toolbar can be introduced to the web browser, through a software download/installation. The INE toolbar will in effect be the INE web browser platform whereby the script within the INE toolbar can establish and manage the content of the platform in coordination with the INE. VERIZON BROADBAND, which as an ISP qualifies as an INE, has a toolbar implementation as shown in FIG. 8. The toolbar can contain a software component or application that is capable of parsing and rendering HTML documents. In the case of the Internet Explorer (IE) web browser, the development of a custom IE toolbar may be facilitated by Microsoft's Visual Studio. Visual Studio is a software development support tool for Windows OS applications, and is typically used in the development of entire “Windows Forms” applications, including games and multimedia products. Visual Studio may also be used to design a custom IE toolbar that can subsequently serve as an add-on component to a generic IE web-browser. Visual Studio can also be used to have the toolbar host a software component capable of parsing and rendering HTML documents. The software component capable of parsing and rendering HTML documents can be the “Mshtml.dll” component. The toolbar can also contain software components capable of displaying other types of documents including but not limited to Flash documents, Shockwave documents and PDF documents. The INE toolbar can be displayed to the user selectively. For example, it can be displayed to the user only when the user is connected to the INE or accessing the web or the Internet via the INE. The INE toolbar can initiate a handshake protocol with the INE, whereby it can send a message to the INE, which is an “Are You There” message. The message may be received by the INE only if the user is connected to the INE or accessing the web or the Internet via the INE. This can be accomplished in several ways including but not limited the following two:
1) The destination IP address for the message can be a private IP address that is known a priori, so that the message cannot be delivered to the INE over the Internet.
2) The toolbar can send out a HTTP request to a static IP address that is known a priori and is reserved for this purpose. If the user is connected to the INE or accessing the web or the Internet via the INE, then the Middleware Module/Intermediate Processing Agent 1002 can recognize that IP address, intercept the request, and return an acknowledgement. Otherwise, the request can go out into the Internet and reach a dummy web server that actually has that IP address. At that point the server can either ignore the request or preferably send a “negative acknowledgement” to the toolbar.

If the user is connected to the INE or is accessing the web or the Internet via the INE, then the INE can send an acknowledgement message back to the toolbar. If the toolbar receives an acknowledgement message it can display itself, otherwise it can not display itself. The toolbar can hide itself while still running in the background by setting its width to 0 pixels

Although the above provides a detailed description using some exemplary methods and approaches, persons skilled in the art would appreciate that one or more benefits of the present invention can also be realized by combining some of the approaches or methods described above. The invention can also be generalized to situation with multiple INE Customers communicating with multiple Content Providers. Also, although the methods described above use JavaScript to implement the procedure, it would be apparent to those skilled in the art that the procedure may be implemented using several other languages (e.g., VBScript and other similar languages) without deviating from the scope of the present invention.

A system for enabling the invention can have an end device for the user, including but not limited to a desktop computer, a laptop computer, a workstation, a smartphone and a PDA. The end device can be equipped with a web browsing software application, such as Internet Explorer or Firefox, and can transmit and receive data using one or more technologies including but not limited to dialup connection, DSL, high-speed Internet by a Cable company, WiFi, WiMax, and cellular connection. The system can also have of one or more web servers, whereby such web servers may be general purpose computers equipped with software applications such as a web server application and a database application. Web servers can be used by Web Page providers (Content Providers), INEs and INE related parties to supply various types of web content. The web servers can transmit and receive data. The system can also have one or more conventional network appliances such as edge routers and proxy servers that additionally contain special-purpose software, and/or one or more general purpose computers containing special-purpose software; whereby the collective special-purpose software (over the network appliances and the general-purpose computers) can allow the INE to perform request modification, response modification, and other steps necessary for introducing toolbars/interstitial content, and delivering modified Web Pages to users.

In yet another aspect of the invention, machine readable media that contain instructions are described. When executed by a machine, the media containing the instructions according to this embodiment of the invention can cause the machine to execute a set of operations to enable an Intermediate Network Entity (INE) to deliver INE content to a user as described in detail above. The INE content can be in the form of a toolbar or interstitial content within a webpage and/or within the web browser. The machine readable medium of this aspect of the invention contain instructions that when executed enable operations resulting in receiving by an Intermediate Network Entity (INE) from a user a request for a Web Page located at a specified web address; processing of the request for the Web Page by the INE; processing the requested Web Page such that the requested Web Page when delivered to the web browser contains at least one toolbar or interstitial content; and delivering the modified Web Page along with the at least one toolbar or interstitial content to the web browser.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A method for rendering an INE platform within a web browser, comprising:
receiving a request for web content located at a specified web address from a web browser by at least one of an INE and a web server;
processing, by an intermediate processing agent within an INE, one or more responses generated by the at least one of an INE and a web server as an answer to the request for the web content, the processing of one or more responses further comprising determining which INE processed response to forward to the web browser from one or more of the following: a procedure that determines one or more parameters of the state of the web browser, a modified response, and an unmodified response;
generating new web content comprising the requested web content and an INE platform; and
rendering the new web content comprising the requested web content and the INE platform to the web browser.

2. The method of claim 1, wherein the INE platform includes content distinct from the requested web content.

3. The method of claim 1, wherein the step of determining which INE processed response to forward is based on at least one of an outcome of a prior processing of a request associated with the response, whether the response includes a redirect directive and content type of the response.

4. (canceled)

5. The method claim of 3, further comprising determining whether the response contains a text HTML file.

6. The method of claim 1, further comprising the step of querying, after an initial rendering of the new web content, the intermediate processing agent as to whether to perform a reload of the new web content.

7. The method of claim of 1, wherein the processing of one or more responses further comprises determining whether a Uniform Resource Identifier (URI) associated with the response is for a pass through object.

8. (canceled)

9. (canceled)

10. The method of claim 1, further comprising the step of providing one or more parameters of the state of the web browser to the INE or an INE proxy.

11. The method of claim 1, wherein the method is implemented using at least one of JavaScript and VBScript.

12. The method of claim 1, further comprising the step of processing a request by the INE.

13. The method of claim 12, wherein the processing the request by the INE involves determining one or more of the following: forwarding the request to the web address, modifying the request prior to forwarding to the web address, and returning a response without forwarding the request to the intended web address.

14. The method of claim 10, wherein the determining further comprises determining whether a Uniform Resource Identifier is flagged.

15. (canceled)

16. The method of claim 1, wherein the new web content comprises a new web page comprising a first frame having an INE platform and a second frame comprising web content from the web server, wherein the first frame and the second frame are both displayed within a single web browser window.

17. The method of claim 1,
wherein the new web content is displayed within the web browser prior to displaying the requested web content.

18.-23. (canceled)

24. The method of claim 13, further comprising displaying the requested content within the web browser in response to an action by an end user.

25. The method of claim 1, wherein the web content is encrypted.

26. The method of claim 1, wherein the web content is encrypted using Transport Layer Security (TLS) or Secure Sockets Layer (SSL) cryptographic protocol.

27. The method of claim 16, wherein the web browser first accepts the processing agent as a trusted authority.

28. A method for rendering an INE platform in the form of a toolbar within a web browser, comprising:
extending functionality of a web browser by installing software to introduce a toolbar,
wherein the toolbar appears selectively based on whether an electronic device is connected to an INE that provides the toolbar, and
wherein the toolbar displays web content.

29. (canceled)

30. A system for providing INE content to a web browser, comprising:
a web browser operably connected to a web server through Internet;
one or more INE servers operably connected to the web browser and the web server;
an intermediate processing agent located between the web browser and the INE, the intermediate processing agent comprising at least one of a redirection agent, and a web content processing agent, the web content processing agent further comprising a request modification agent, a response modification agent, and a proxy server,
wherein the intermediate processing agent contains software applications which when implemented provides the web browser with INE content.

31. A machine readable medium storing instructions that, if executed by the machine, cause the machine to execute a set of operations enabling an INE to place INE content within a web browser comprising:
receiving a request for web content located at a specified web address from a web browser by at least one of an INE and a web server;
processing, by an intermediate processing agent within an INE, one or more responses generated by the at least one of an INE and a web server as an answer to the request for the web content, the processing of one or more responses further comprises making a determination on which INE processed response to forward to the web browser from one or more of the following: a procedure that determines one or more parameters of the state of the web browser, a modified response, and an unmodified response;
generating new web content comprising the requested web content and an INE platform; and
rendering the new web content comprising the requested web content and the INE platform to the web browser.
